(19) United States
(12) Patent Application Publication
(10) Pub. No.: US 2025/0072419 A1
(43) Pub. Date: Mar. 6, 2025

(54) SYSTEMS AND METHODS FOR APPLICATION OF ACTIVE INGREDIENTS TO CANNABIS

(71) Applicant: Hazel Technologies, Inc., Chicago, IL (US)

(72) Inventors: Adam Truett Preslar, London (GB); Derick Augustin Jiwan, Roselle, IL (US)

(73) Assignee: Hazel Technologies, Inc., Chicago, IL (US)

(21) Appl. No.: 18/633,608

(22) Filed: Apr. 12, 2024

Related U.S. Application Data
(63) Continuation of application No. 18/189,284, filed on Mar. 24, 2023, now abandoned.
Application No. 18/189,284 is a continuation of application No. PCT/US2021/052824, filed on Sep. 30, 2021.
(60) Provisional application No. 63/086,210, filed on Oct. 1, 2020.

(51) Int. Cl. A01N 27/00; A01C 21/00; A01N 25/08; A01P 21/00

(52) U.S. Cl. CPC A01N 27/00; A01C 21/00; A01N 25/08; A01P 21/00

(57) ABSTRACT

Systems and methods for application of active ingredients to plants such as cannabinoid-producing plants (e.g., plants in the genus Cannabis) are generally described. Certain aspects of this disclosure relate to systems for treating cannabinoid-producing plants (e.g., plants of the genus Cannabis such as those containing Cannabis sativa, Cannabis indica, or combinations thereof) involving fluidic communication between the plants and a source of a cyclopropene (e.g., in an enclosure). In some embodiments, cannabinoid-producing plants (e.g., plants of the genus Cannabis) are exposed to a cyclopropene (e.g., 1-methylcyclopropene in a gas phase). Some embodiments involve such exposure inducing potentially desirable phenomena with the plants, such as growth of male sex organs on female plants and/or enhancement of plant biomass.

### RELATED APPLICATIONS

This application is a continuation of U.S. patent application Ser. No. 18/189,284, filed Mar. 24, 2023, and entitled “Systems and Methods for Application of Active Ingredients to Cannabis,” which is a continuation of International Patent Application No. PCT/US2021/052824, filed Sep. 30, 2021 and entitled “Systems and Methods for Application of Active Ingredients to Cannabis,” which claims priority under 35 U.S.C. § 119(e) to U.S. Provisional Patent Application No. 63/086,210, filed Oct. 1, 2020, and entitled “Systems and Methods for Application of Active Ingredients to Cannabis,” each of which is incorporated herein by reference in its entirety for all purposes.

### TECHNICAL FIELD

Systems and methods for application of active ingredients to plants such as cannabinoid-producing plants are generally described.

### BACKGROUND

Cannabinoid-producing plants such as plants of the genus Cannabis may be treated during various stages of growth to afford desirable properties. In the production of Cannabis sativa for recreational or medicinal use, the female plant phenotype is typically the commercially valuable sex. This is because female inflorescences produce the highest concentration of cannabinol (CBD) and Δ-9-tetrahydrocannabidiol (THC) compared to male inflorescences and are also able to produce viable seed. In commercial production, male plants are often destroyed as seed formation reduces flower quality. Thus, there is interest for growers to have access to feminized seeds to produce all-female crops.

Cannabis sativa is dioecious and therefore produces male and female inflorescences on different plants. As in many organisms, the male and female plants are naturally produced roughly 1:1 during normal sexual reproduction. Cannabis sex determination is analogous to mammalian sex determination, wherein females carry two copies of the female chromosome (‘X’) and males carry one copy each of a male (‘Y’) and female (‘X’) chromosome. The production of all female seeds may involve induction of female plants to develop male flowers that produce genetically female pollen containing only ‘X’ gametes. That is, the production of all female seeds may involve induction of female plants to develop male organs (e.g., within a female cone having one or more flowers). When these pollens are crossed with eggs from a female plant, all-female seed can be produced.

Therefore, improved systems, methods, and/or compositions related to treatment of cannabinoid-producing plants (e.g., plants of the genus Cannabis) are desirable.

### SUMMARY

Systems and methods for application of active ingredients to plants such as cannabinoid-producing plants (e.g., plants in the genus Cannabis) are generally described. Certain aspects of this disclosure relate to systems for treating cannabinoid-producing plants (e.g., plants of the genus Cannabis such as those containing Cannabis sativa, Cannabis indica, or combinations thereof) involving fluidic communication between the plants and a source of a cyclopropene (e.g., in an enclosure). In some embodiments, cannabinoid-producing plants (e.g., plants of the genus Cannabis) are exposed to a cyclopropene (e.g., 1-methylcyclopropene in a gas-phase). Some embodiments involve such exposure inducing potentially desirable phenomena, such as growth of male sex organs on female plants and/or enhancement of plant biomass. The subject matter of the present invention involves, in some cases, interrelated products, alternative solutions to a particular problem, and/or a plurality of different uses of one or more systems and/or articles.

In one aspect, systems for treating cannabinoid-producing plants are provided. In some embodiments, a system for treating a cannabinoid-producing plant comprises a source of a cyclopropene and the plant in fluidic communication with the source of cyclopropene.

In some embodiments, a system for treating a cannabinoid-producing plant comprises a source of a cyclopropene and the plant, wherein a distance between the source of the cyclopropene and the plant is less than or equal to 50 m.

In another aspect, compositions are provided. In some embodiments, a composition comprises a cannabinoid-producing plant and a cyclopropene in contact with the plant.

In another aspect, methods are provided. In some embodiments, a method comprises exposing a cannabinoid-producing plant to a cyclopropene.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A shows a cross-sectional schematic illustration of a cannabinoid-producing plant in an enclosure;

FIG. 1B shows a cross-sectional schematic illustration of a cannabinoid-producing plant and a source of a cyclopropene in an enclosure, according to some embodiments;

FIG. 2 shows a cross-sectional schematic illustration of an exemplary composition comprising a porous adsorbent material and a cyclopropene associated with the porous adsorbent material, according to some embodiments;

FIGS. 3-6 are images showing stamen growth on a cannabinoid-producing plant at varying time points during and following treatment with 1-methylcyclopropene, according to some embodiments;

FIG. 7 is an image showing three 1-MCP-treated plants (top) and three control plants (bottom), according to some embodiments;

FIG. 8 is a plot of total cannabinoid concentration profiles in treated and control cannabinoid-producing plants at varying time points, according to some embodiments; and

FIGS. 9A-9C are plots of concentration profiles of the cannabinoids THCA (FIG. 9A), THCVA (FIG. 9B), and CBGA (FIG. 9C) in treated and control cannabinoid-producing plants at varying time points, according to some embodiments.

### DETAILED DESCRIPTION

Systems and methods for application of active ingredients to plants such as cannabinoid-producing plants (e.g., plants in the genus Cannabis) are generally described. Certain aspects of this disclosure relate to systems for treating cannabinoid-producing plants (e.g., plants of the genus Cannabis such as Cannabis sativa, Cannabis indica, or combinations thereof) involving fluidic communication between the plants and a source of a cyclopropene (e.g., in an enclosure). In some embodiments, cannabinoid-producing plants (e.g., plants of the genus Cannabis) are exposed to a cyclopropene (e.g., 1-methylcyclopropene (1-MCP) in a gas-phase). Some embodiments involve such exposure inducing potentially desirable phenomena with the plants, such as growth of male sex organs on female plants and/or enhancement of plant biomass.

It may be desirable to apply active ingredients to cannabinoid-producing plants (e.g., plants of the genus Cannabis) to promote certain properties. For example, it may be desirable to treat Cannabis plants to modify their sex morphology. It has been reported that ethylene, auxins, and cytokinin promote formation of female flowers on male plants, whereas gibberellins promote formation of male flowers on female plants. It has also been reported that inhibiting ethylene sensitivity using silver containing-solutions results in genetically female plants producing male flowers, complete with anthers and viable pollen. As female plants do not have the corresponding male chromosome, the only fertile pollen produced after this process will carry the female sex chromosome. When that ‘feminized’ pollen is used to pollinate a female plant, an overwhelming majority of the offspring may be genetically and phenotypically female. As a result, seed produced from ‘feminized’ pollen is also called ‘feminized’ and generally commands a much higher market price than do non-feminized seeds, since it can be depended on to result in only, or substantially only, commercially important plants for recreational and medicinal use. Inducing feminized pollen growth in female plants may also be desirable by allowing for production of seeds having relatively uniform, consistent genetics. Female Cannabis plants produce flowering bodies generally rich in commercially important substances such as cannabidiol (CBD). Therefore, ensuring production of female plants (via growth of male organs on female plants) increases yield of those substances.

However, it has been realized in the context of this disclosure that existing ethylene desensitizers for Cannabis plants (e.g., benzothiadiazole, gibberellic acid, silver thiosulphate, silver nitrate, and colloidal silver) are typically hazardous to workers, produce waste that is environmentally toxic and expensive to dispose of, and/or are extremely labor-intensive to deploy, requiring hand-spraying to each plant and often several applications. For example, silver compounds are illegal in many states and countries for ethylene inhibition for these reasons. The inventors herein have realized that application of cyclopropenes such as 1-MCP is an alternative way of ethylene desensitization to counter the disadvantages of the current commercialized products available. Moreover, the inventors have, surprisingly, observed that cannabinoid-producing plants (e.g., plants of the genus Cannabis) can be successfully treated with cyclopropenes (e.g., in a gas phase) and display phenotypical changes such as growth of male organs such as stamens without deleterious effects on growth, biomass, or cannabinoid production. It has also been realized that cyclopropenes may be applied to plants homogeneously and without labor intensive processes (e.g., via fumigation) rather than needing foliar sprays that present hazards and result in primarily localized effects in the plants. Exposure of cannabinoid-producing plants (e.g., plants of the genus Cannabis) to cyclopropenes such as 1-MCP may promote other desirable results, such as increases in yield, longer stability of the plants and plant matter (e.g., following harvest), and greater extent of flowering.

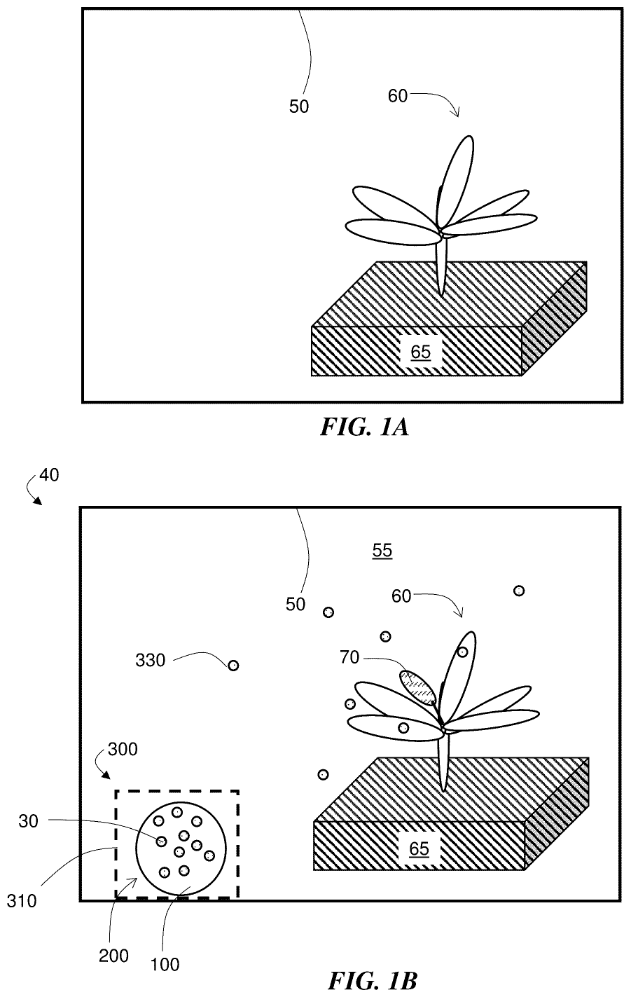

Systems and methods for application of active ingredients such as cyclopropene to cannabinoid-producing plants such as those of the genus Cannabis are generally described. In some embodiments, a system for treating a cannabinoid-producing plant (e.g., plant of the genus Cannabis) comprises the plant and a source of a cyclopropene (e.g., in an enclosure), each of which are described in more detail below. For example, FIGS. 1A-1B show schematic illustrations of enclosure 50 comprising plant 60 growing in soil 65 in the absence (FIG. 1A) and in the presence (FIG. 1B) of source of cyclopropene 300. Various embodiments are directed to configurations and methods for exposing cannabinoid-producing plants (e.g., plants of the genus Cannabis) to cyclopropene (e.g., from the source of the cyclopropene). In some embodiments, the cyclopropene is 1-methylcyclopropene.

In some embodiments, the system for treating a cannabinoid-producing plant (e.g., plant of the genus Cannabis) comprises the plant and a source of a cyclopropene (e.g., 1-MCP) in fluidic communication with the plant. As used herein, two elements are in fluidic communication with each other when fluid (e.g., gas-phase cyclopropene, liquid solution comprising cyclopropene, etc.) can be transported from one of the elements to the other of the elements without otherwise altering the configurations of the elements or a configuration of an element between them (such as a valve). For example, in system 40 in FIG. 1B, source of cyclopropene 300 is in fluidic communication with plant 60 because source of cyclopropene 300 is under a configuration such that cyclopropene gas 330 can be transported from source of cyclopropene 300 to plant 60. In some embodiments, the source of the cyclopropene is configured such that it is always in fluidic communication with the plant (e.g., such as a composition capable of releasing cyclopropene through a fluid-permeable form factor). However, in some embodiments, the source of cyclopropene is such that it is in fluidic communication with the plant in a first configuration (e.g., a pipe outlet with an open valve) but is capable of having fluidic communication cut off in a second configuration (e.g., the pipe outlet with the valve closed).

Having a source of a cyclopropene and a cannabinoid-producing plant (e.g., plant of the genus Cannabis) be in fluidic communication with each other is one way in which the plant may be exposed to cyclopropene (e.g., released from the source of the cyclopropene). Such exposure may be part of a treatment process for the plant (e.g., to affect phenotype, to affect biomass and/or growth characteristics, etc.)

As mentioned above, in some embodiments, the plant is a cannabinoid-producing plant. Cannabinoid-producing plants are generally known in the art, and are understood to produce one or more cannabinoids (non-limiting examples of which are described below). In some embodiments, the plant is of the genus Cannabis. As is generally known, the genus Cannabis includes species Cannabis sativa, Cannabis indica, and Cannabis ruderalis. One of ordinary skill in the art would understand distinctions between plants (and their corresponding genetics and ancestries) belonging to the species Cannabis sativa, Cannabis indica, and Cannabis ruderalis. In some embodiments, the plant comprises genes from the species Cannabis sativa, Cannabis indica, and/or Cannabis ruderalis.

In some embodiments, the plant is a plant purely of one of the species Cannabis sativa, Cannabis indica, and Cannabis ruderalis. For example, in some embodiments, the plant is purely of the species Cannabis sativa (e.g., the plant's genetics are exclusively attributable to ancestry from the species Cannabis sativa). In some embodiments, the plant is purely of the species Cannabis indica (e.g., the plant's genetics are exclusively attributable to ancestry from the species Cannabis indica). In some embodiments, the plant is purely of the species Cannabis ruderalis (e.g., the plant's genetics are exclusively attributable to ancestry from the species Cannabis ruderalis).

In some embodiments, the plant is a hybrid plant. That is, the plant may be from a variety of Cannabis plants having genes from multiple different species of cannabinoid-producing plants (e.g., multiple different species of plants of the genus Cannabis). In some embodiments, the plant comprises genes from two or more species chosen from Cannabis sativa, Cannabis indica, and Cannabis ruderalis. For example, the plant may be of a strain having ancestry from both Cannabis sativa and Cannabis indica. The strain of the plant may affect any of a variety of properties of the plant, such as types and ratios of active compositions such as THC and CBD, flowering properties, utility for industrial purposes (e.g., as hemp), etc. Breeding the plant may allow one to tune the plant's properties according to desired use. It has been observed herein that the variety of the plant may affect its sensitivity to undergoing phenotypical changes or changes in production of biomass and/or cannabinoids upon exposure to cyclopropenes such as 1-MCP.

A relatively high percentage of the plant's ancestry may be attributable to Cannabis sativa. In some embodiments, the plant has an ancestry containing at least 1%, at least 2%, at least 5%, at least 10%, at least 20%, at least 30%, at least 40%, at least 50%, at least 60%, and/or up to 70%, up to 80%, up to 90%, up to 95%, up to 98%, up to 99%, or 100% Cannabis sativa. In some embodiments, the plant has an ancestry containing less than or equal to 100%, less than or equal to 90%, less than or equal to 80%, less than or equal to 50%, less than or equal to 20%, less than or equal to 10%, less than or equal to 5%, less than or equal to 1%, or 0% Cannabis sativa. Those of ordinary skill in the art would understand the use of ancestry percentages in characterizing strains of plants of the genus Cannabis. For example, a 50/50 hybrid strain of Cannabis sativa and Cannabis indica would be considered to have an ancestry containing 50% Cannabis sativa and 50% Cannabis indica.

A relatively high percentage of the plant's ancestry may be attributable to Cannabis indica. In some embodiments, the plant has an ancestry containing at least 1%, at least 2%, at least 5%, at least 10%, at least 20%, at least 30%, at least 40%, at least 50%, at least 60%, and/or up to 70%, up to 80%, up to 90%, up to 95%, up to 98%, up to 99%, or 100% Cannabis indica. In some embodiments, the plant has an ancestry containing less than or equal to 100%, less than or equal to 90%, less than or equal to 80%, less than or equal to 50%, less than or equal to 20%, less than or equal to 10%, less than or equal to 5%, less than or equal to 1%, or 0% Cannabis indica.

A relatively high percentage of the plant's ancestry may be attributable to Cannabis ruderalis. In some embodiments, the plant has an ancestry containing at least 1%, at least 2%, at least 5%, at least 10%, at least 20%, at least 30%, at least 40%, at least 50%, at least 60%, and/or up to 70%, up to 80%, up to 90%, up to 95%, up to 98%, up to 99%, or 100% Cannabis ruderalis. In some embodiments, the plant has an ancestry containing less than or equal to 100%, less than or equal to 90%, less than or equal to 80%, less than or equal to 50%, less than or equal to 20%, less than or equal to 10%, less than or equal to 5%, less than or equal to 1%, or 0% Cannabis ruderalis. Combinations of the ranges above are possible. For example, the plant may be of a variety having ancestry containing at least 40% and up to 60% Cannabis sativa and at least at least 40% and up to 60% Cannabis indica.

In some embodiments, the plant in the system and/or exposed to the cyclopropene is a female plant. As mentioned above, some embodiments relate to treating female cannabinoid-producing plants (e.g., plants of the genus Cannabis) such that the plant undergoes commercially valuable phenomena. For example, in some embodiments, the plant is a female plant comprising a male organ. The plant may comprise a male organ based at least in part on exposure of the plant to a cyclopropene in accordance with certain embodiments herein. For example, as shown in FIG. 1A, female plant 60 grown in enclosure 50 but in the absence of any source of cyclopropene may lack male organs. However, as shown in FIG. 1B, plant 60 grown in enclosure 50 of system 40 comprising source of cyclopropene 300 may be exposed to released cyclopropene 330 (e.g., in a gas phase) such that plant 60 grows stamen 70, according to certain embodiments. Production of male organs on a female plant may afford production of genetic material by the plant (e.g., in seeds) having two X chromosomes, thereby ensuring production of further female plants and limiting or preventing production of male plants, which can be less commercially valuable. The male organ of the female plant (e.g., induced by exposure to the cyclopropene) may be a male flower. In some embodiments, the plant is a female cannabinoid-producing plant (e.g., plant of the genus Cannabis) comprising one or more stamens (e.g., at least 1 stamen, at least 2 stamens, at least 3 stamens, at least 5, and/or up to 10 stamens, up to 20 stamens or more). In some embodiments, the one or more stamens include anthers. The anthers may include pollen. Without being bound by any particular theory, it is believed that cyclopropenes may induce production of male organs (e.g., male flowers, stamens) in female Cannabis plants by associating with ethylene receptors of the plant. For example, in some embodiments, upon exposure to cyclopropene (e.g., 1-MCP), a molecule of the cyclopropene may bind an ethylene receptor of the plant (e.g., by forming a specific noncovalent affinity interaction or a chemical bond such as a covalent bond with the ethylene receptor). Such an association may induce biological signaling in the plant resulting in the production of the male organ.

Any of a variety of sources of cyclopropene may be suitable, depending on the desired exposure conditions. In some embodiments, the source of the cyclopropene comprises the cyclopropene. The source of the cyclopropene may be any composition or fluidic device capable of causing cyclopropene to be available to the plant. In some embodiments, the source of the cyclopropene comprises a composition capable of releasing cyclopropene (e.g., spontaneously, upon exposure to a non-equilibrium condition, upon exposure to a liquid displacing medium). For example, in FIG. 1B, source of cyclopropene 300 is shown as chemical composition 200 in form factor 310 and comprising porous adsorbent material 100 associated with cyclopropene molecules 30. In accordance with some embodiments, source of cyclopropene 300 may be capable of releasing associated cyclopropene (e.g., via desorption, displacement, and/or dissolution) such that released cyclopropene 330 can be transported away from source of cyclopropene 300. Further examples and descriptions of possible chemical compositions for the source of cyclopropene are described in more detail below.

In some embodiments, the source of the cyclopropene is a fluidic device capable of outputting cyclopropene molecules. For example, in some embodiments the source of the cyclopropene comprises a fluidic outlet (e.g., a pipe opening, optionally actuatable with a valve). The fluidic outlet may be fluidically connected to a reservoir of the cyclopropene (e.g., in a solid, liquid, and/or gas phase). In some embodiments the reservoir is a container containing the cyclopropene. In some embodiments in which the systems herein include enclosures for the plant and source, some or all of the reservoir fluidically connected to the fluidic outlet is also within the enclosure. However, in some embodiments, the fluidic outlet is fluidically connected (e.g., via one or more fluidic conduits such as pipes) to a reservoir of cyclopropene outside the enclosure.

As mentioned above, in some embodiments, the source of the cyclopropene comprises the cyclopropene (e.g., the source comprises a composition comprising the cyclopropene associated to an internal and/or external surface of a porous adsorbent material). The cyclopropene (e.g., 1-MCP) may be present in the source of the cyclopropene in an amount of greater than or equal to 0.01 wt %, greater than or equal to 0.02 wt %, greater than or equal to 0.05 wt %, greater than or equal to 0.1 wt %, greater than or equal to 0.2 wt %, greater than or equal to 0.5 wt %, greater than or equal to 1.0 wt %, or greater. In some embodiments, the cyclopropene (e.g., 1-MCP) is present in the source of the cyclopropene in an amount of less than or equal to 50 wt %, less than or equal to 20 wt %, less than or equal to 10 wt %, less than or equal to 5 wt %, less than or equal to 2 wt %, or less. Combinations of these ranges (e.g., greater than or equal to 0.01 wt % and less than or equal to 50 wt %, greater than or equal to 0.1 wt % and less than or equal to 20 wt %, or greater than or equal to 0.5 wt % and less than or equal to 2 wt %) are possible. In some embodiments in which cyclopropene is released from the source of the cyclopropene, the above weight percentages of the cyclopropene correspond to loadings prior to such release.

In some, but not necessarily all embodiments, the system for treating a cannabinoid-producing plant (e.g., plant of the genus Cannabis) comprises an enclosure. The enclosure may at least partially enclose the source of the cyclopropene and the plant. In some embodiments, the enclosure completely encloses the source of the cyclopropene and the plant. For example, in FIG. 1B, enclosure 50 completely encloses source of cyclopropene 300 and plant 60 such that released cyclopropene 330 is prevented from exiting enclosure 50. In some embodiments, the enclosure comprises solid walls and/or a solid ceiling, and optionally a floor. For example, the enclosure may be, for example, a greenhouse (e.g., configured to maintain a concentration of the cyclopropene in a headspace of the greenhouse). In some embodiments, the enclosure is a chamber (e.g., a chamber capable of being fluidically sealed and having an interior volume in which one or more plants may be grown). In some embodiments, the enclosure comprises one or more additional components for growing plants. For example, the enclosure may comprise one or more light sources and/or one or more water sources (e.g., for irrigation).

The enclosure may have any of a variety of sizes, depending for example on the number of plants being grown and/or treated. The enclosure may define a volume (e.g., in which the plant and source of cyclopropene reside) of greater than or equal to 0.1 m³, greater than or equal to 0.2 m³, greater than or equal to 0.5 m³, greater than or equal to 1 m³, greater than or equal to 2 m³, greater than or equal to 5 m³, and/or up to 8 m³, up to 10 m³, up to 20 m³, up to 50 m³, up to 100 m³, or more.

In some embodiments, the source of the cyclopropene and the plant are not at least partially enclosed (e.g., by an enclosure). For example, in some embodiments, the system comprises a source of the cyclopropene and the plant in an open area, such as an outdoor field (e.g., on farmland). In some such embodiments lacking an enclosure, the source of the cyclopropene is configured to expose the plant to the cyclopropene via a liquid phase (e.g., via foliar spraying). In other such embodiments lacking an enclosure, the source of the cyclopropene may be configured to expose the plant to the cyclopropene in a gas phase, with the source of the cyclopropene being in contact with the plant or relatively close to the plant (e.g., within 1 m, within 0.5 m, within 200 cm, within 100 cm, within 50 cm, within 10 cm, within 1 cm, or less). A relatively close distance between the source and the plant may promote exposure of the plant to gas-phase cyclopropene at sufficiently high concentrations (e.g., prior to dilution via diffusion).

Any of a variety of distances between the source of the cyclopropene and the plant may be used, depending for example on the nature of the source and the method of exposure. In some embodiments, the source of the cyclopropene is in contact with the plant. For example, the source of the cyclopropene may be a composition comprising the cyclopropene in a form factor from which the cyclopropene is released, and that form factor may be placed in contact with the plant (e.g., hanging from a plant, placed on the plant, etc.). In some embodiments, the source of the cyclopropene is located at a distance from the plant. For example, the source may be located at a distance from the plant for methods of exposure involving releasing gas-phase cyclopropene (e.g., for fumigation of the enclosure). In some embodiments, a distance between the source of the cyclopropene and the plant is large enough to promote homogeneous exposure of the plant to the cyclopropene (e.g., during gas phase methods). For example, in some embodiments, a distance between the source of the cyclopropene and the plant is greater than or equal to 1 cm, greater than or equal to 10 cm, greater than or equal to 50 cm, greater than or equal to 1 m, greater than or equal to 5 m, or greater. In some embodiments, a distance between the source of the cyclopropene and the plant is not so large that the cyclopropene is dispersed so much that low atmospheric concentrations of the cyclopropene surrounding the plant result unless large quantities of cyclopropene are released. For example, in some embodiments, a distance between the source of the cyclopropene and the plant is less than or equal to 50 m, less than or equal to 20 m, less than or equal to 10 m, less than or equal to 5 m, or less. Combinations of these ranges (e.g., greater than or equal to 1 cm and less than or equal to 50 m, greater than or equal to 10 cm and less than or equal to 20 m) are possible. The distance between the source and the plant in this context refers to a smallest distance from a point of release of the cyclopropene from the source to an above-soil part of the plant.

As mentioned above, certain embodiments involve exposing a cannabinoid-producing plant (e.g., plant of the genus Cannabis) to a cyclopropene (e.g., 1-MCP). Exposure of a plant to a substance generally refers to causing the plant to be in contact with the substance (at an exterior surface of the plant and/or within the plant matter). One way in which a plant may be in contact with a cyclopropene is by having cyclopropene molecules associate with receptors of the plant (e.g., ethylene receptors). Another way in which a plant may be in contact with a cyclopropene is where molecules of the cyclopropene are within 1 mm, within 500 microns, within 100 microns, within 50 microns, within 10 microns, within 5 microns, within 1 micron, within 100 nm, within 50 nm, within 10 nm, within 5 nm, within 1 nm, or closer to any part of the plant. For example, in an embodiment in which at least some gas-phase molecules of the cyclopropene are within such a close distance as described above, that plant is considered to be in contact with a cyclopropene. As another example, a plant in contact with a liquid comprising the cyclopropene (e.g., following spraying of the plant with the liquid) is also considered to be a plant in contact with a cyclopropene.

The exposing step may result in the cyclopropene interacting with biological phenomena of the plant (e.g., by binding receptors such as ethylene receptors). Such an exposure may be accomplished in any of a variety of ways. For example, some embodiments comprise exposing the plant to a cyclopropene, where the cyclopropene is in a gas-phase. For example, a cyclopropene gas (e.g., 1-MCP gas) may be released from the source of the cyclopropene such that gas-phase molecules are transported to the plant and contact the plant (e.g., via diffusion, convection, and/or driven circulation such as by air-handling systems). For example, in FIG. 1B, released cyclopropene 330 is in a gas phase and can contact plant 60 within enclosure 50. One example of gas-phase exposure is fumigating an enclosure containing the plant with gas-phase cyclopropene. In some embodiments involving exposing the plant to cyclopropene in the gas-phase, a relatively large percentage of the total amount of cyclopropene to which the plant is exposed is in the gas-phase (e.g., at least 10 wt %, at least 25 wt %, at least 50 wt %, at least 75 wt %, at least 90 wt %, at least 95 wt %, at least 98 wt %, at least 99 wt %, or 100 wt % of the total amount of cyclopropene to which the plant is exposed is in the gas phase). Another approach to exposing the plant with the cyclopropene is contacting the plant with the cyclopropene in the liquid phase (e.g., using a liquid mixture comprising the cyclopropene in a liquid solvent). Liquid-phase cyclopropene may be applied, for example, via spraying (e.g., from a nozzle), misting, pouring, squirting, and the like.

In some embodiments, the plant is exposed to the cyclopropene such that the cyclopropene contacts the plant homogeneously with respect to the outer surfaces of the plant. That is, in some embodiments, a flux of cyclopropene is relatively uniform throughout the outer surfaces of the above-soil parts of the plant (e.g., within 50%, within 20%, within 10%, within 5%, within 2%, within 1%, or less of the average flux experienced by the above-soil parts of the plant) during exposure. It has been realized that this approach can result in some instances in desired changes in the plant (e.g., phenotypical changes) in a homogeneous manner. Such homogeneous effects (e.g., homogeneous distribution of male organs, homogeneous distribution of increased biomass) stands in contrast to certain existing methods for applying active ingredients to cannabinoid-producing plants (e.g., plants of the genus Cannabis), which typically involve techniques such as foliar spraying that tend to result in localized effects in the plants. Localized effects are typically less desirable. One exemplary way to contact the plant homogeneously with the cyclopropene molecules is to contact the plant with gas-phase cyclopropene molecules (e.g., via fumigation).

Some embodiments comprise control releasing the cyclopropene from the source such that the plant is exposed to the cyclopropene. Techniques for control release of active ingredients such as cyclopropenes are described in more detail below. Control release of cyclopropene may allow for the plant to be exposed to a flux of cyclopropene for a desired duration (e.g., such that desirable effects in the plant are achieved.).

Some embodiments comprise releasing the cyclopropene from a source of the cyclopropene at a rate of greater than or equal to 0.1 μL/g/hr, greater than or equal to 0.2 μL/g/hr, greater than or equal to 0.5 μL/g/hr, greater than or equal to 1 μL/g/hr, greater than or equal to 2 μL/g/hr, greater than or equal to 5 μL/g/hr, greater than or equal to 10 μL/g/hr, greater than or equal to 20 μL/g/hr, greater than or equal to 50 μL/g/hr, and/or up to 100 μL/g/hr, up to 200 μL/g/hr, up to 500 μL/g/hr, up to 1000 μL/g/hr, or more. Such a rate may be with respect to a mass of a composition comprising the cyclopropene (e.g., a mass of a porous adsorbent material and associated cyclopropene). In some embodiments, the cyclopropene is released at rates in the above ranges at hour 1 following commencement of release (e.g., via exposure to a non-equilibrium condition or a displacement medium).

It has been realized that an amount and/or duration of exposure of the cannabinoid-producing plant (e.g., plant of the genus Cannabis) can affect resulting phenomena. It has been realized that exposure to too little of the cyclopropene (e.g., too low a concentration and/or too short of a duration) can result in no or attenuated effects being observed in the plant. It has also been realized that exposure to too much of the cyclopropene (e.g., too high of a concentration and/or too long of a duration) can result in deleterious effects in the plant, such as stunted growth or other types of harm, and/or safety concerns (such as explosion hazards). In some embodiments, a concentration of the cyclopropene in an environment surrounding the plant (e.g., in the air or headspace surrounding the plant) and the source of the cyclopropene is greater than or equal to 1 ppb, greater than or equal to 10 ppb, greater than or equal to 100 ppb, greater than or equal to 200 ppb, greater than or equal to 500 ppb, greater than or equal to 1 ppm, greater than or equal to 2 ppm, greater than or equal to 3 ppm, greater than or equal to 5 ppm, greater than or equal to 10 ppm, and/or up to 15 ppm, up to 20 ppm, up to 30 ppm, up to 40 ppm, up to 50 ppm, up to 100 ppm, or more. As an example, such a concentration may be attained in the enclosure (e.g., by sealing the enclosure). For example, in FIG. 1B, environment 55 in enclosure 50 may have a concentration of released cyclopropene in any of the ranges above. In some embodiments, an exposure step comprises establishing a concentration of the cyclopropene in an environment surrounding the plant and the source of the cyclopropene in any of these ranges for a period of time of greater than or equal to 1 hour, greater than or equal to 2 hours, greater than or equal to 4 hours, greater than or equal to 6 hours, greater than or equal to 12 hours, greater than or equal to 18 hours, greater than or equal to 24 hours, and/or up to 48 hours, up to 72 hours, up to 96 hours, or more. In some embodiments, the concentration of the cyclopropene (e.g., 1-MCP) is reduced following such an exposure step (e.g., such that no observable 1-MCP is in the surrounding environment). In some embodiments, exposure steps involving establishing concentrations in the above ranges for the above periods of time are performed at least 1 time, at least 2 times, at least 3 times, at least 4 times, at least 5 times, at least 10 times, or more. Time intervals between exposure steps (e.g., during which no further cyclopropene may be released) may be, for example, greater than or equal to 12 hours, greater than or equal to 24 hours, greater than or equal to 2 days, greater than or equal to 3 days, greater than or equal to 5 days, greater than or equal to 1 week, greater than or equal to 2 weeks, greater than or equal to 5 weeks, or more.

Exposure of the cannabinoid-producing plant (e.g., plant of the genus Cannabis) may be performed during any of a variety of time periods with respect to the life cycle and/or harvest of the plant. As is generally known, cannabinoid-producing plants (e.g., plants of the genus Cannabis) undergo various stages of development including a seedling stage, a vegetative stage, a flowering stage, and, ultimately harvesting. In some embodiments, a step of exposing a cannabinoid-producing plant (e.g., plant of the genus Cannabis) to the cyclopropene (e.g., 1-MCP) is started within 10 weeks, within 7 weeks, within 5 weeks, or within 3 weeks, within 2 weeks, within 1 week, or less of the plant entering a vegetative stage. In some such embodiments, a first exposure of the plant to the cyclopropene occurs within this time period. In some embodiments, a step of exposing a cannabinoid-producing plant (e.g., plant of the genus Cannabis) to the cyclopropene (e.g., 1-MCP) is started at least 1 day, at least 2 days, at least 3 days, at least 5 days, at least 1 week, at least two weeks, or more after the plant begins its vegetative stage. It has been realized that early exposure of the plants to the cyclopropene may promote greater inducement of desirable biological effects (e.g., growth of male organs on female plants, changes in biomass, changes in phenotypical properties such as color, etc.) than if exposure occurs later in the plant's development cycle. However, it has also been realized that exposing the plant to the cyclopropene too early in the plant's development may cause undesirable results such as harm to the plant.

In some embodiments, the step of a step of exposing a cannabinoid-producing plant (e.g., plant of the genus Cannabis) to the cyclopropene (e.g., 1-MCP) is performed prior to a flowering period of the plant (e.g., at least 1 weeks, at least 2 weeks, or more prior to the flowering period). In some embodiments, no steps of exposing the plant to the cyclopropene is performed during a flowering period of the plant. However, in some embodiments, a step of exposing a cannabinoid-producing plant (e.g., plant of the genus Cannabis) to the cyclopropene is performed during a flowering period of the plant (e.g., within 3 weeks of flowering, within 2 weeks of flowering, within 1 week of flowering, or less).

In some embodiments, exposure of the plant to a cyclopropene induces a phenotypical change in the plant. As mentioned above, in some embodiments, exposure to the cyclopropene induces formation of male organs (e.g., male flowers, stamens) on female cannabinoid-producing plants (e.g., plants of the genus Cannabis). In some embodiments, exposure to the cyclopropene causes the plant to have coloring different than the plant would have in the absence of exposure. For example, in some instances, exposure to the cyclopropene causes the plant to have a purple coloring. Such a purple coloring may be more desirable to consumers in some instances. With the benefit of this disclosure, one of ordinary skill would be able to select and/or screen for varieties (e.g., hybrid strains) of cannabinoid-producing plants (e.g., Cannabis plants) able to undergo the described phenotypical changes and/or biomass/cannabinoid profile effects.

It has been observed herein that, in some instances, exposure of cannabinoid-producing plants (e.g., plants of the genus Cannabis) to cyclopropene causes the plant to have a biomass (e.g., total biomass and/or trimmed biomass) greater than would otherwise be observed. It has also been observed herein that in some instances exposure of plants to cyclopropene does not cause a significant reduction in biomass (e.g., total biomass and/or trimmed biomass). For example, in some embodiments, following the exposing step, the plant has a biomass greater than an equivalent plant not subjected to the exposing step but grown under otherwise identical conditions (e.g., by a factor of greater than or equal to 1.01, greater than or equal to 1.02, greater than or equal to 1.05, greater than or equal to 1.1, and/or up to 1.2, up to 1.3, or greater). In some embodiments, following the exposing step, the plant has a biomass within 20%, within 10%, within 5%, within 2%, within 1%, or equal to an equivalent plant not subjected to the exposing step but grown under otherwise identical condition. In this context, an equivalent plant refers to a plant of the same genotype and at the same point of development.

It has been observed herein that, in some instances, exposure of plants to cyclopropene does not cause a significant reduction in cannabinoid content in the plant. In some embodiments, following the exposing step, the plant has a total amount cannabinoids within 20%, within 10%, within 5%, within 2%, within 1%, or equal to an equivalent plant not subjected to the exposing step but grown under otherwise identical conditions. In some embodiments, following the exposing step, the plant has an amount of an individual cannabinoid within 20%, within 10%, within 5%, within 2%, within 1%, or equal to an equivalent plant not subjected to the exposing step but grown under otherwise identical condition. As would be understood by one of ordinary skill in the art, a percentage difference is measured relative to the lower value. For example, if the total amount of cannabinoids following the exposing step is 20 wt % and the total amount of cannabinoids in an equivalent plant not subjected to the exposing step but grown under otherwise identical conditions is 22 wt %, then the total amount of cannabinoids in the plant following the exposing step is within 10% of the total amount of cannabinoids in an equivalent plant not subjected to the exposing step but grown under otherwise identical conditions (because [22 wt %−20 wt %]/20 wt %×100%=10%). As another example, if the total amount of cannabinoids following the exposing step is 22 wt % and the total amount of cannabinoids in an equivalent plant not subjected to the exposing step but grown under otherwise identical conditions is 20 wt %, then the total amount of cannabinoids in the plant following the exposing step is within 10% of the total amount of cannabinoids in an equivalent plant not subjected to the exposing step but grown under otherwise identical conditions (because, again, [22 wt %−20 wt %]/10 wt %×100%=10%).

Individual cannabinoids include, but are not limited to cannabinol (CBD), Δ-9-tetrahydrocannabidiol (THC), tetrahydrocannabinolic acid (THCA), tetrahydrocannabivarinic acid (THCVA), cannabigerolic acid (CBGA), cannabidiolic acid (CBDA), cannabidivarinic acid (CBDVA), and cannabichromenic acid (CBCA). Suitable conditions and techniques for quantitative measurement of biomass (total or trimmed) and cannabinoids are described in the examples below.

It has been observed herein that phenotypical changes or biomass/cannabinoid profile effects upon cyclopropene exposure may be dependent on the variety of cannabinoid-producing plant (e.g., plant of the genus Cannabis) exposed, as described in the examples below. With the benefit of this disclosure, one of ordinary skill would be able to select and/or screen for varieties (e.g., hybrid strains) of Cannabis plants able to undergo the described phenotypical changes and/or biomass/cannabinoid profile effects.

As used herein cyclopropene compounds are also referred to interchangeably as “cyclopropene” or “cyclopropenes”. Additionally, one or more cyclopropene compounds as used herein can mean one cyclopropene compound or more than one cyclopropene compound (e.g., two cyclopropene compounds, three cyclopropene compounds, or more). In some embodiments, cyclopropenes comprise organic compounds containing any unsubstituted or substituted three-carbon cyclic ring with an unsaturated or olefinic bond (of the root formula C₃Hₓ), or any organic compound containing a cyclopropene moiety. The simplest example of this class of molecules is cyclopropene, the simplest cycloalkene. The cyclopropene unit has a triangular structure. Cyclopropenes also include cyclopropene derivatives, such as 1-methylcyclopropene (1-MCP; molecular formula C₄H₆), or other cyclopropene derivatives (including, but not limited to borirenes, phosphirenes, and silirenes, which are boron-, phosphorus-, and silicon-substituted cyclopropenes respectively).

As used herein, a cyclopropene compound, also referred to herein interchangeably as a cyclopropene or cyclopropenes, is any compound with the formula

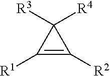

where each R¹, R², R³ and R⁴ is independently selected from the group consisting of H and a chemical group of the formula:

-(L)ᵤ-Z,

where n is an integer from 0 to 12, each L is a bivalent radical, and Z is a monovalent radical, Non-limiting examples of L groups include radicals containing one or more atoms selected from H, B, C, N, O, P, S, Si, or mixtures thereof. The atoms within an L group may be connected to each other by single bonds, double bonds, triple bonds, or mixtures thereof. Each L group may be linear, branched, cyclic, or a combination thereof. In any one R group (e.g., any one of R¹, R², R³ and R⁴) the total number of heteroatoms (e.g., atoms that are neither H nor C) is from 0 to 6. Independently, in any one R group the total number of non-hydrogen atoms is 50 or less. Non-limiting examples of Z groups are hydrogen, halo, cyano, nitro, nitroso, azido, chlorate, bromate, iodate, isocyanato, isocyanido, isothiocyanato, pentafluorothio, and a chemical group G, wherein G is a 3 to 14 membered ring system.

The R¹, R², R³, and R⁴ groups may be independently selected from the suitable groups. Among the groups that are suitable for use as one or more of R¹, R², R³, and R⁴ are, for example, aliphatic groups, aliphatic-oxy groups, alkylphosphonato groups, cycloaliphatic groups, cycloalkylsulfonyl groups, cycloalkylamino groups, heterocyclic groups, aryl groups, heteroaryl groups, halogens, silyl groups, other groups, and mixtures and combinations thereof. Groups that are suitable for use as one or more of R¹, R², R³, and R⁴ may be substituted or unsubstituted.

Among the suitable R¹, R², R³, and R⁴ groups are, for example, aliphatic groups. Some suitable aliphatic groups include, for example, alkyl, alkenyl, and alkynyl groups. Suitable aliphatic groups may be linear, branched, cyclic, or a combination thereof. Independently, suitable aliphatic groups may be substituted or unsubstituted.

As used herein, a chemical group of interest is said to be “substituted” if one or more hydrogen atoms of the chemical group of interest is replaced by a substituent.

Also among the suitable R¹, R², R³, and R⁴ groups are, for example, substituted and unsubstituted heterocyclyl groups that are connected to the cyclopropene compound through an intervening oxy group, amino group, carbonyl group, or sulfonyl group; examples of such R¹, R², R³, and R⁴ groups are heterocyclyloxy, heterocyclylcarbonyl, diheterocyclylamino, and diheterocyclylaminosulfonyl.

Also among the suitable R¹, R², R³, and R⁴ groups are, for example, substituted and unsubstituted heterocyclic groups that are connected to the cyclopropene compound through an intervening oxy group, amino group, carbonyl group, sulfonyl group, thioalkyl group, or aminosulfonyl group; examples of such R¹, R², R³, and R⁴ groups are diheteroarylamino, heteroarylthioalkyl, and diheteroarylaminosulfonyl.

Also among the suitable R¹, R², R³, and R⁴ groups are, for example, hydrogen, fluoro, chloro, bromo, iodo, cyano, nitro, nitroso, azido, chlorato, bromato, iodato, isocyanato, isocyanido, isothiocyanato, pentafluorothio; acetoxy, carboethoxy, cyanato, nitrato, nitrito, perchlorato, allenyl, butylmercapto, diethylphosphonato, dimethylphenylsilyl, isoquinolyl, mercapto, naphthyl, phenoxy, phenyl, piperidino, pyridyl, quinolyl, triethylsilyl, trimethylsilyl; and substituted analogs thereof.

As used herein, the chemical group G is a 3 to 14 membered ring system. Ring systems suitable as chemical group G may be substituted or unsubstituted; they may be aromatic (including, for example, phenyl and naphthyl) or aliphatic (including unsaturated aliphatic, partially saturated aliphatic, or saturated aliphatic); and they may be carbocyclic or heterocyclic. Among heterocyclic G groups, some suitable heteroatoms are, for example, nitrogen, sulfur, oxygen, and combinations thereof. Ring systems suitable as chemical group G may be monocyclic, bicyclic, tricyclic, polycyclic, spiro, or fused; among suitable chemical group G ring systems that are bicyclic, tricyclic, or fused, the various rings in a single chemical group G may be all the same type or may be of two or more types (for example, an aromatic ring may be fused with an aliphatic ring).

In one embodiment, one or more of R¹, R², R³, and R⁴ is hydrogen or (C₁-C₁₀) alkyl. In another embodiment, each of R¹, R², and R³ is hydrogen or (C₁-C₈) alkyl. In another embodiment, each of R¹, R², R³, and R⁴ is hydrogen or (C₁-C₄) alkyl. In another embodiment, each of R¹, R², R³, and R⁴ is hydrogen or methyl. In another embodiment, R¹ is (C₁-C₄) alkyl and each of R², R³, and R⁴ is hydrogen. In another embodiment, R¹ is methyl and each of R², R³, and R⁴ is hydrogen, and the cyclopropene compound is known herein as 1-methylcyclopropene or “1-MCP.”

In some embodiments, the cyclopropene is released from a composition comprising a porous adsorbent material. For example, in some embodiments, a source of a cyclopropene (e.g., in fluidic communication with a cannabinoid-producing plant (e.g., plant of the genus Cannabis) and/or in an enclosure with the plant) comprises the cyclopropene associated with a porous adsorbent material. A variety of potentially suitable porous adsorbent materials may be used with the guidance of this disclosure, including but not limited to carbon material and/or silicate materials. In some embodiments, the porous adsorbent material comprises combinations of porous solids (e.g., soft rocks such as diatomaceous earth). In some embodiments, the porous adsorbent material comprises a gelatinous material. For example, the porous adsorbent material may be collagen-derived (e.g., gelatin). In some embodiments, the porous adsorbent material comprises a mixture of different types of materials (e.g., a mixture that includes both a carbon material and a silicate material, or a mixture that includes both diatomaceous earth and gelatin).

Adsorbent materials are generally capable of associating and retaining a second substance under at least one set of conditions. It should be understood that while adsorbent materials may, in some instances, associate the second substance (e.g., on to internal or external surfaces of the adsorbent) via adsorption, any of a variety of specific or non-specific interactions may contribute to association either alone or in combination, depending on the physical and chemical properties of the respective materials. An adsorbent material may associate other substances in an amount greater than or equal to 0.01 wt %, greater than or equal to 0.1 wt %, greater than or equal to 1 wt %, greater than or equal to 5 wt %, and/or up to 10 wt %, up to 25 wt %, up to 45 wt %, or up to 50 wt % versus the total weight of the adsorbent material and the associated substance.

As described in more detail below, a porous adsorbent material may comprise any of a variety of pores, such as macropores, mesopores, and/or micropores. The presence of pores may promote desirable release profiles for active ingredients (e.g., cyclopropenes) by providing sufficient surface area for association of active ingredients, while in some instances tuning release rates (e.g., by affecting diffusion properties of associated active ingredient).

In some embodiments, the cyclopropene is associated with the porous adsorbent material. The cyclopropene may be associated with the porous adsorbent material in any of a variety of manners, and methods and systems described herein are not limited to any particular mechanism of association. In some embodiments, the cyclopropene is adsorbed to an interior and/or exterior surface of the porous adsorbent material. Adsorption of the cyclopropene to a surface may be primarily based on non-specific forces such as van der Waals forces. However, in some embodiments, a cyclopropene may be specifically associated with the porous adsorbent material via any of a variety of interactions such as covalent bonds, electrostatic interactions, pi-pi stacking, or specific noncovalent affinity interactions (e.g., via a functional group and/or complexing agent immobilized on a surface of the porous adsorbent material). In some embodiments, the cyclopropene is associated with the porous adsorbent material via adhesive forces. For example, a liquid cyclopropene may associate with a porous adsorbent material via capillary forces when wetting a surface of the porous adsorbent material.

In some embodiments, the cyclopropene is within a bulk of the porous adsorbent material. Being within a bulk of the porous adsorbent material (e.g., within an inner 80% of the macroscopic volume of the porous adsorbent material) as opposed to being solely associated with an outer macroscopic surface of the porous adsorbent material may contribute at least in part to relatively high loadings of the cyclopropene as well as a tuning of release rates of the cyclopropene. In some embodiments, the cyclopropene is within at least some of the pores of the porous adsorbent material (e.g., adsorbed to a surface within pores of the porous adsorbent substrate).

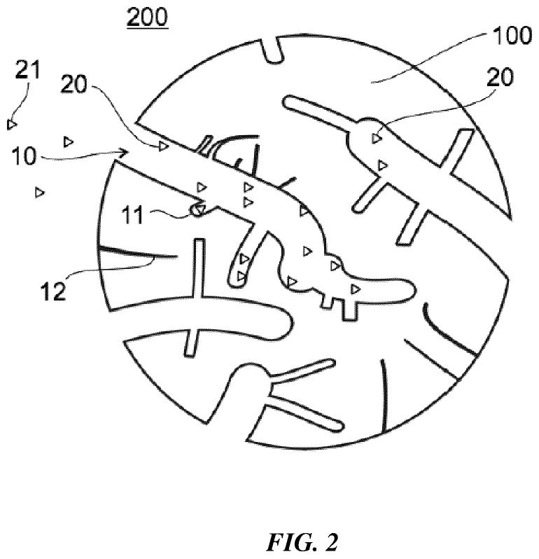

FIG. 2 shows a cross-sectional schematic illustration of a non-limiting illustrative embodiment of matrix 200 comprising cyclopropene 20 and porous adsorbent material 100. In a non-limiting embodiment, a matrix consists essentially of porous adsorbent material 100 and cyclopropene 20. In the schematic illustration in FIG. 2, matrix 200 contains at least one macropore 10, at least one mesopore 11, and at least one micropore 12. In a non-limiting embodiment, at least one of the macropore 10, mesopore 11, and micropore 12 contains cyclopropene 20. Matrix 200 illustrates cyclopropene 20 contained in macropores 10 and mesopores 11 of the matrix 200. Micropores 12 may also contain cyclopropene 20. As FIG. 2 is a non-limiting example and is not drawn to scale, it should be noted that other storage concentrations of cyclopropene 20 in matrix 200 can be achieved by the embodiments contemplated herein. Moreover, different positions of cyclopropene 20 within the pores 10, 11, 12 of matrix 200 are also contemplated. In a non-limiting embodiment, cyclopropene 20 is 1-MCP.

FIG. 2 also illustrates cyclopropene 21. Cyclopropene 21 is the same cyclopropene as cyclopropene 20; however, cyclopropene 21 has been released or liberated from matrix 200. The matrices herein may be configured for release of cyclopropene. In a non-limiting embodiment the cyclopropene is in the gas phase.

In some embodiments, the porous adsorbent material comprises one or more of macropores, mesopores, and micropores. In a non-limiting embodiment, macropores are pores having a diameter greater than 50 nm. For example, macropores may have diameters of between 50 and 1000 nm. In a non-limiting embodiment, mesopores are pores having a diameter between 2 nm and 50 nm. In a non-limiting embodiment, micropores are pores having a diameter of less than 2 nm. For example, micropores may have diameters of between 0.2 and 2 nm. Pore diameters may be determined using, for example, the method of Barrett, Joyner, and Halenda in ASTM Standard Test Method D4641-17.

In some embodiments, at least 10%, at least 25%, at least 50%, at least 75%, at least 90%, at least 95%, at least 98%, at least 99%, or more of the total pore volume of the adsorbent material is occupied by pores having a pore diameter of at least 0.1 nm, at least 0.2 nm, at least 0.5 nm, at least 1 nm, at least 2 nm, at least 5 nm, at least 10 nm, at least 20 nm, at least 50 nm, or greater. In some embodiments, at least 10%, at least 25%, at least 50%, at least 75%, at least 90%, at least 95%, at least 98%, at least 99%, or more of the total pore volume of the adsorbent material is occupied by pores having a pore diameter less than or equal to 1000 nm, less than or equal to 500 nm, less than or equal to 200 nm, less than or equal to 100 nm, less than or equal to 50 nm, less than or equal to 20 nm, less than or equal to 10 nm, less than or equal to 5 nm, less than or equal to 2 nm, or less. Combinations of these ranges are possible.

In some embodiments, the porous adsorbent material is a solid material having a high surface area, as described in more detail herein. Without wishing to be limited by any particular theory or mechanism, porous, high surface area materials may be beneficial in some applications due to their adsorption capacity and sufficient affinity arising from that adsorption capacity to exhibit volatile retention (e.g., of cyclopropenes) greater than the evaporation retention of a neat liquid. In a non-limiting embodiment, a high-surface area material is a material with a total chemical surface area, internal and external, of at least 100 m²/g. In some embodiments, a high-surface area material is a material with a total chemical surface area, internal and external, greater than or equal to 400 m²/g. In some embodiments, a high-surface area material is a material with a total chemical surface area, internal and external, of at least 500 m²/g. In some embodiments, a high-surface area material is a material with a total chemical surface area, internal and external, greater than or equal to 1000 m²/g. In some embodiments, a high-surface area material is a material with a total chemical surface area, internal and external, greater than or equal to 2000 m²/g. The terms “total chemical surface area, internal and external”, “chemical surface area” and “surface area” are used interchangeably herein.

In an embodiment, a porous adsorbent material has a surface area in the range of 100 to 1500 m²/g. In an embodiment, a porous adsorbent material has a surface area in the range of 300 to 1500 m²/g. In an embodiment, a porous adsorbent material has a surface area in the range of 500 to 1500 m²/g. In an embodiment, a porous adsorbent material has a surface area in the range of 600 to 1500 m²/g. In an embodiment, a porous adsorbent material has a surface area in the range of 650 to 1500 m²/g. In an embodiment, a porous adsorbent material has a surface area in the range of 650 to 1300 m²/g. In an embodiment, a porous adsorbent material has a surface area in the range of 650 to 1200 m²/g. In an embodiment, a porous adsorbent material has a surface area in the range of 800 to 1200 m²/g. In an embodiment, a porous adsorbent material has a surface area in the range of 850 to 1200 m²/g. In an embodiment, a porous adsorbent material has a surface area in the range of 900 to 1200 m²/g. In an embodiment, a porous adsorbent material has a surface area in the range of 900 to 1150 m²/g. In an embodiment, a porous adsorbent material has a surface area in the range of 900 to 1500 m²/g. Those of ordinary skill in the will be aware of methods for determining the total chemical surface area, internal and external, for example, using Brunauer-Emmett-Teller (BET) analysis of nitrogen or noble gas desorption when a material (e.g., a porous material) is exposed to vacuum at a given temperature, for instance as by the ISO 9277 standard.

In some embodiments, the source of cyclopropene comprises a porous adsorbent material comprising a carbon material. A carbon material may be of various geometries and formations including, but not limited to, macroporous, mesoporous, and microporous carbon materials, monolithic carbon materials, extruded or pelletized carbon materials, steam-activated carbon materials, oxidized carbon materials, or acid- or base-treated carbon materials. In some embodiments, the following carbon materials may be used as porous absorbent materials for the sources of cyclopropene described herein: carbon black (e.g., such as generally indicated by CAS No.: 1333-86-4) or lampblack carbon; activated carbon (also referred to as activated charcoal) (e.g., such as generally indicated by CAS No.: 7440-44-0); carbon in powder, granule, film, or extrudate form; optionally, carbon mixed with one or more adjuvants or diluents; carbon (e.g., activated carbon) sold commercially; carbon derived from coconut, coal, wood, anthracite, or sand (Carbon Activated Corporation) and the like; reactivated carbon; ash, soot, char, charcoal, coal, or coke; vitreous carbon; glassy carbon; bone charcoal. Each of those carbons, whether commercially acquired or manufactured by hand as known in the art can be further modified to form other porous adsorbent materials for the release device described herein by operations including, but not limited to heat treating materials, oxidation, and/or acid- or base-treatment to arrive at other porous adsorbent materials and matrices described herein. Therefore, any carbons derived from, for example: carbon black or lampblack carbon, activated carbon or activated charcoal, carbon in powder, granule, film, or extrudate form reactivated carbon, ash, soot, char, charcoal, coal, or coke, vitreous carbon, glassy carbon, or bone charcoal through the modification of the parent carbon with, for example, adsorption-modifying functionalities, one or more acids, bases, oxidants, hydrolyzing reagents, or a combination thereof may be used to form the compositions described herein. Non-limiting examples of carbon materials are described in U.S. Patent Application Publication No. US 2019/0037839 published on Feb. 7, 2019 and entitled “Compositions for Controlled Release of Active Ingredients and Methods of Making Same,” which is incorporated herein by reference in its entirety for all purposes.

In a non-limiting embodiment, a porous adsorbent material that is a carbon material comprises carbon in an amount of greater than or equal to 75 wt %, greater than or equal to 80 wt %, greater than or equal to 90 wt %, greater than or equal to 93 wt %, greater than or equal to 94 wt %, greater than or equal to 95 wt %, and/or up to 99 wt %, or up to 100 wt %.

In some embodiments where the porous adsorbent material comprises a carbon material, a relatively high percentage of the carbon material is elemental carbon (carbon having an oxidation state of 0). In some embodiments, the carbon material comprises elemental carbon in an amount of greater than or equal to 50 atomic percent (at %), greater than or equal to 75 at %, greater than or equal to 90 at %, greater than or equal to 95 at %, greater than or equal to 98 at %, and/or up to 99 at %, or up to 100 at %.

In some embodiments, the porous adsorbent material has a relatively high iodine number. In some embodiments, the porous adsorbent material (e.g., a carbon material, a silicate material) has an iodine number of greater than or equal to 0 mg/g, greater than or equal to 100 mg/g, greater than or equal to 200 mg/g, greater than or equal to 500 mg/g, greater than or equal to 800 mg/g, greater than or equal to 1000 mg/g, and/or up to 1200 mg/g, up to 1500 mg/g, up to 2000 mg/g, or higher. Combinations of these ranges (e.g., greater than or equal to 0 mg/g and less than or equal to 2000 mg/g, greater than or equal 500 mg/g and less than or equal to 2000 mg/g, or greater than or equal to 800 mg/g and less than or equal to 1200 mg/g) are possible.

In a non-limiting embodiment, the composition comprises a porous adsorbent material being a silicate material, (also referred to herein as a silica-based material). Silica-based materials generally include silicon atoms and oxygen atoms at least some of which are bound to silicon atoms. The silicon atoms and the oxygen atoms may be present in the silica-based material, for example, in the form of oxidized silicon. Silica-based materials include materials that are or comprise silicon dioxide, other forms of silicates, and combinations thereof. Silica-based materials may include, in addition to the silicon and oxygen atoms, other materials such as metal oxides (e.g., aluminum oxide (Al₂O₃)). Silica-based materials may include organosilicate hybrids. In some embodiments, the amount of silicon atoms, by weight, in the silica-based material is at least 1 wt %, at least 3 wt %, at least 5 wt %, at least 10 wt %, or at least 20 wt %. In some embodiments, the amount of oxygen atoms, by weight, in the silica-based material is at least 1 wt %, at least 3 wt %, at least 5 wt %, at least 10 wt %, or at least 20 wt %. In certain embodiments, the total amount of the silicon atoms and the oxygen atoms within the silica-based material is at least 1 wt %, at least 3 wt %, at least 5 wt %, at least 10 wt %, at least 20 wt %, at least 25 wt %, at least 30 wt %, at least 40 wt %, at least 50 wt %, at least 60 wt %, at least 70 wt %, at least 80 wt %, at least 90 wt %, at least 95 wt %, or at least 99 wt %.

In a non-limiting embodiment, the porous adsorbent material (e.g., the silica-based material) is or comprises a silicate. Silicates may include neosilicates, sorosilicates, cyclosilicates, inosilicates, phyllosilicates, and tectosilicates. In some embodiments, the porous adsorbent material comprises silicate in an amount of at least 1 wt %, at least 3 wt %, at least 5 wt %, at least 10 wt %, at least 20 wt %, at least 25 wt %, at least 30 wt %, at least 40 wt %, at least 50 wt %, at least 60 wt %, at least 70 wt %, at least 80 wt %, at least 90 wt %, at least 95 wt %, and/or up to 99 wt % or 100 wt %.

In some embodiments, the porous adsorbent material comprises silicon dioxide in an amount of at least 1 wt %, at least 3 wt %, at least 5 wt %, at least 10 wt %, at least 20 wt %, at least 25 wt %, at least 30 wt %, at least 40 wt %, at least 50 wt %, at least 60 wt %, at least 70 wt %, at least 80 wt %, at least 90 wt %, at least 95 wt %, and/or up to 99 wt % or up to 100 wt %.

A silica-based material may be of various geometries and formations including, but not limited to, macroporous, mesoporous, and microporous silica-based materials, amorphous silica, fumed silica, particulate silica of all sizes, ground quartz, particulate, fumed, crystalline, precipitated, and ground silicon dioxide and associated derivatives, and combinations thereof. In some embodiments, a silica based material comprises silica gel, or precipitated, crystalline-free silica gel (such as generally indicated by CAS No.: 112926-00-8), or amorphous, fumed (crystalline free) silica (such as generally indicated by CAS No.: 112945-52-5), or mesostructured amorphous silica (such as generally indicated by CAS No.: 7631-86-9). In some embodiments, silica-based material further comprises one or more of a metal oxide, metalloid oxide, and combinations thereof. For example, in some embodiments, the silica-based porous adsorbent material further comprises one or more of zinc oxide, titanium oxide, group 13 or 14 oxide, and combinations thereof. In some embodiments, silica-based porous adsorbent material further comprises aluminum oxide or a portion of aluminum oxide.

In some embodiments, a porous adsorbent material comprising a silica-based material comprises silica. Silicate materials are available from commercial sources in a wide array of states with respect to surface areas, porosities, degrees of surface functionalization, acidity, basicity, metal contents, and other chemical and physicochemical features. Commercial silicates may be in the form of powder, granules, nanoscale particles, and porous particles. In some embodiments, the porous adsorbent material comprises silica gel. In some embodiments, the silica-based porous adsorbent material comprises one or more of macroporous, mesoporous, and microporous silica. In some embodiments the porous adsorbent material comprises precipitated, crystalline-free silica gel (such as generally indicated by CAS No.: 112926-00-8). In some embodiments, the porous adsorbent material comprises amorphous, fumed (crystalline free) silica (such as generally indicated by CAS No. 112945-52-5). In some embodiments, the porous adsorbent material comprises mesostructured amorphous silica (such as generally indicated by CAS No. 7631-86-9).

In some embodiment, a source of a cyclopropene comprises a composition comprising a porous adsorbent material impregnated with cyclopropene, the composition incorporated into a form factor. For example, in FIG. 1B, source of cyclopropene 300 comprises optional form factor 310 comprising composition 200. In some embodiments, the form factor comprises a packet, pouch, sachet, or pad. In some embodiments, the composition is incorporated into a form factor by being sealed inside the form factor. In some embodiments, the form factor comprises a porous material. In a non-limiting embodiment, the form factor is comprised of a material that is one or more of food safe, non-absorptive, air permeable (but not necessarily porous). In some embodiments, the one or more of food safe, non-absorptive, air permeable (but not necessarily porous) structure comprises a sachet. In a non-limiting embodiment, the sachet is porous. In an embodiment, the porous adsorbent material is charged with cyclopropene prior to being deposited and sealed in a sachet. For example, the sachet may be prepared by depositing the composition in the sachet and then sealing the sachet.

In some embodiments, the form factor comprises PE (polyethylene) [whether HDPE (high density polyethylene) or LDPE (low density polyethylene)], PLA (polylactic acid), starch, PP (polypropylene), nylon, PET (polyethylene terephthalate), non-woven fabric or paper, paper, burlap (as from jute, hemp or another fiber), cellulose-based material, polyester, or any combination thereof. In some embodiments, the form factor is a sachet which comprises polyethylene (e.g., TYVEK™). In some embodiments, the form factor is a sachet made of polyethylene (e.g., TYVEK™). In a non-limiting embodiment, the sachet may be perforated. In a non-limiting embodiment, the Gurley Hill porosity measurement of a sachet material is 20-50 sec/100 cm²-in, or 30-40 sec/100 cm²-in, or 45-60 sec/100 cm²-in, 60-150 sec/100 cm²-in, or 100-400 sec/100 cm²-in, or 300-400 sec/100 cm²-in. In an embodiment, the form factor material is food-safe. In an embodiment, the sachet material is food-safe.

In a non-limiting embodiment, a source of a cyclopropene contains porous adsorbent material in an amount of greater than or equal to 0.1 g, greater than or equal to 0.25 g, greater than or equal to 0.5 g, greater than or equal to 1 g, greater than or equal to 2 g, greater than or equal to 5 g, greater than or equal to 10 g, greater than or equal to 20 g, greater than or equal to 50 g, greater than or equal to 100 g, greater than or equal to 500 g, and/or up to 1 kg, up to 2 kg, up to 5 kg, up to 10 kg, up to 100 kg, or more.

In some embodiments, the source of the cyclopropene comprises a composition capable of control releasing the cyclopropene. In some such instances, the composition is configured to control release the cyclopropene (e.g., by having one or more physicochemical properties that promotes control release such as porosity, pore diameter, surface area, surface chemistry or density). Examples of compositions for controlled release of active ingredients such as cyclopropenes are described in U.S. Patent Application Publication No. US-2019-0037839 published on Feb. 8, 2019 and entitled “Compositions for Controlled Release of Active Ingredients and Methods of Making Same”, International Patent Application Publication No. WO2017/143311 published on Aug. 24, 2017 and entitled “Compositions for Controlled Release of Active Ingredients and Methods of Making Same,” and International Patent Application Publication No. WO2019/133076 published on Jul. 4, 2019 and entitled “Compositions and Methods for Release of Cyclopropenes,” each of which is incorporated herein by reference in its entirety for all purposes.

The release rates of cyclopropene out of the compositions described herein are, unless otherwise stated, reported in relation to the amount of cyclopropene (e.g., as a volume or mass) released per gram of matrix (i.e. the matrix being the porous adsorbent material and the cyclopropene) per unit time. In some embodiments, the mass (e.g., in grams) of the matrix used in the calculation to report release rate is the matrix (e.g., the matrix being the porous adsorbent material charged with cyclopropene) measured in grams immediately prior to hour zero of the release test. The release characteristics for the compositions described herein as indicated by release rate of cyclopropene are given for release tests starting “hour zero” conditions. In some embodiments, “hour zero” means composition exposure to a non-equilibrium condition. In some embodiments in which a liquid displacement medium is used, “hour zero” means composition 1) exposure to a liquid displacing medium, and 2) exposure to a non-equilibrium condition, not necessarily in that order. In some embodiments, composition exposure to a liquid displacing medium is contact with a liquid displacing medium. In some embodiments, exposure to a liquid displacing medium comprises contact with a liquid displacing medium. In some embodiments, composition contact with a liquid displacing medium comprises agitation of a composition with a liquid displacing medium. In some embodiments, composition exposure to a liquid displacing medium comprises contact and agitation of a composition with a liquid displacing medium. In some embodiments, “hour zero” or “time zero” begin before agitation of the matrix and the liquid displacing medium. In some embodiments, “hour zero” or “time zero” begin after agitation of the matrix and the liquid displacing medium. In some embodiments, “hour zero” or “time zero” begins after sufficient agitation of the matrix and the liquid displacing medium. In some embodiments, “hour zero” or “time zero” begin after agitation of the matrix and liquid displacing medium slurry. In some embodiments, agitation of the matrix and the liquid displacing medium occurs after time zero but before the first sample timepoint (e.g., hour 1). In an embodiment, exposure to a non-equilibrium condition is a condition that is not a liquid displacing medium. A non-limiting example of exposure to a non-equilibrium condition is composition exposure to ambient room temperature (approximately 23-25° C.) and atmospheric pressure, with none of the cyclopropene detected in the atmosphere prior to commencement of the release test. It should be understood that throughout the duration of a release test, temperature and atmospheric pressure around the composition material is kept substantially constant. It should be further understood that the atmospheric concentration of the cyclopropene may vary throughout the duration of the release test as the cyclopropene is released from the composition into the surrounding atmosphere.

In some embodiments wherein quantification of cyclopropene release rate from the composition reported as an amount of cyclopropene (e.g., a volume or mass) released per gram of matrix (i.e. the matrix being the porous adsorbent material and the cyclopropene) per unit time, the rate of release is reported on a per hour basis. The rate of release of cyclopropene per gram of composition per hour may be determined for a particular hour (e.g., hour 22) by measuring the amount of cyclopropene released from the composition over a period of time (e.g., sixty (60) minutes) immediately preceding the particular hour (e.g., hour 22) at which the rate is reported. For example, the release rate on a per hour basis reported for hour 22 is calculated based on the amount (e.g., as a volume or mass) of cyclopropene released from a composition during the sixty (60) minutes which commences at hour 21 and ending at hour 22. The amount of cyclopropene released from the composition (e.g., calculated as a volume or a mass of cyclopropene released during that period of sixty (60) minutes) is then divided by the total mass of the matrix (e.g., as measured in grams) prior to hour zero of the release test to arrive at a release rate as an amount of cyclopropene released per gram of matrix per hour. As would be appreciated by one of ordinary skill of the art, the total mass of the matrix measured prior to hour zero, also known as the total mass of matrix initially measured or known, is the total mass of the matrix prior to exposure to a liquid displacing medium.

A non-limiting example of how to measure the release rate of a cyclopropene from a composition at hour 1 is as follows. The mass of the matrix (e.g., the matrix being a porous adsorbent material charged with cyclopropene) to be studied is measured or known (e.g., in grams). The release study commences at hour zero when the composition is either a) exposed to a non-equilibrium condition, or b) exposed to a liquid displacing medium and a non-equilibrium condition, as the case may be. In a non-limiting embodiment, “hour zero” as it relates to composition exposure to a liquid displacing medium may begin after a vial, jar, or container containing the matrix (comprising a porous adsorbent material and the cyclopropene) and the liquid displacing medium has been sufficiently agitated, for example, for 30 seconds, for 1 minute, or 5 minutes, or 10 minutes, or 15 minutes, or 20 minutes.

The cyclopropene released from the composition over the subsequent sixty (60) minutes is collected (e.g., in a sealed vial) and sampled (e.g., using conventional headspace methodologies) at hour 1, which occurs sixty (60) minutes after hour zero. The sample of the cyclopropene collected is then measured (e.g., using a gas chromatograph (GC)). The amount (e.g., as a volume or mass) of cyclopropene released as calculated from the GC measurement is then divided by the total mass of the matrix (e.g., in grams) as initially measured or known, as discussed above. The resulting numerical figure is the amount (e.g., as a volume or mass) of the cyclopropene released per gram matrix per hour at hour 1.

A non-limiting example of how to measure the release rate of a cyclopropene from the same composition (e.g., during the same release test) at hour 22 is as follows. After the cyclopropene collected over the sixty (60) minutes commencing at hour zero and ending at hour 1 is sampled at hour 1, the vial is left open to allow the cyclopropene to escape. At sixty (60) minutes prior to the next sample time (e.g., hour 22 in this case) the vial is again sealed to allow the cyclopropene to collect for one hour. In other words, the vial is sealed at hour 21 in anticipation of a measurement sample to be taken at hour 22. The cyclopropene released from the composition during the sixty (60) minutes from hour 21 to hour 22 is collected and promptly sampled (e.g., using conventional headspace methodologies) at hour 22. The sample of the cyclopropene collected is then measured using GC analysis. The amount (e.g., as a volume or mass) of the cyclopropene released as calculated from the GC measurement is then divided by the mass of the matrix as initially measured or known (e.g., the same matrix mass used in the calculation for hour 1). The resulting numerical figure is the amount (e.g., as a volume or mass) of the cyclopropene released per gram matrix per hour at hour 22.

Those of ordinary skill in the art will be aware of conventional headspace methodologies that use, for example, gas chromatography (GC). A non-limiting example of a method that uses headspace analysis to measure release rate of cyclopropene is provided as follows. The composition or a sample of the matrix comprising the cyclopropene, is placed in a vial for analysis (e.g., at hour zero, when the composition is either a) exposed to a non-equilibrium condition, or b) exposed to a liquid displacing medium and a non-equilibrium condition, and the vial may be sealed. The rate of release may be calibrated based on the number of hours or minutes that the cyclopropene is permitted to build up in the vial while the vial is sealed. For a period of time (e.g., one (1) hour) prior to each sampling time point, the gas phase cyclopropene may be permitted to build up in the vial. At all other times, the vial may be left open to allow the cyclopropene to escape. Doing so may reduce and/or eliminate any effects of equilibrium adsorption. Depending on the length of time the cyclopropene is permitted to build-up while the vial is sealed, the rate of release at a given time point can be calculated by sampling the headspace of the vial and injecting a sample volume (e.g., 100 L to 300 L) in a GC in accordance with methods known to those of ordinary skill in the art. The area of the GC peak may be calibrated by comparison against an internal standard. For example, for calculating the release of 1-methylcyclopropene (1-MCP) from a matrix, the area of the GC peak may be calibrated against known quantities of 1-MCP released from ETHYLBLOC™ (FLORALIFE®; Walterboro, South Carolina). 1-MCP in the form of ETHYLBLOC™ is obtainable as a 0.14 wt % solid powder.

As discussed above, release may be quantified as a rate of release, which may be reported as an amount of cyclopropene (as a volume or mass, for example) released per gram of matrix per hour (μL cyclopropene/g matrix/hr). In some embodiments, the rate of release reported is the amount (e.g., as a volume or mass) of cyclopropene released per gram of matrix during the hour (e.g., sixty (60) minutes) leading up to the sample time point.

In some embodiments, upon and/or after exposing the composition to a liquid displacing medium, the rate at which the cyclopropene is released is modified relative to the rate at which the cyclopropene was being released by the composition prior to the exposure of the composition to the liquid displacing medium. In some embodiments, upon and/or after exposing the composition to a liquid displacing medium, the rate at which the cyclopropene is released is accelerated relative to the rate at which the cyclopropene was being released by the composition prior to the exposure of the composition to the liquid displacing medium. In some embodiments, upon and/or after exposing the composition to a liquid displacing medium, the rate at which the cyclopropene is released is decelerated relative to the rate at which the cyclopropene was being released by the composition prior to the exposure of the composition to the liquid displacing medium.

In some embodiments, a composition that initially control releases a cyclopropene upon exposure to a non-equilibrium condition that is not a liquid displacing medium subsequently accelerates cyclopropene release after or upon exposure to a liquid displacing medium. In some embodiments, a composition that initially control releases a cyclopropene upon exposure to a non-equilibrium condition that is not a liquid displacing medium subsequently decelerates cyclopropene release after or upon exposure to a liquid displacing medium.

In some embodiments, a composition having a first release rate of cyclopropene at a particular timepoint (e.g., hour 1, hour 22) after time zero exposure to a non-equilibrium condition has a second release rate at the same particular timepoint after time zero exposure to a liquid displacing medium and the non-equilibrium condition. For example, in an embodiment, a sample of a composition is exposed to a non-equilibrium condition (e.g., air) at time zero, the composition having a first release rate of cyclopropene one hour after the exposure to the non-equilibrium condition (air, in this example); another sample of the composition is exposed to the non-equilibrium condition (air, in this example) and to a liquid displacing medium at time zero, the composition having a second release rate of cyclopropene one hour after the exposure to the non-equilibrium condition (air, in this example and to the liquid displacing medium). In some embodiments, composition exposure to a liquid displacing medium is contact with a liquid displacing medium. In some embodiments, composition exposure to a liquid displacing medium comprises contact with a liquid displacing medium. In some embodiments, composition contact with a liquid displacing medium comprises agitation of a composition with a liquid displacing medium. In some embodiments, composition exposure to a liquid displacing medium comprises contact and agitation of a composition with a liquid displacing medium. In some embodiments, agitation of the matrix and the liquid displacing medium occurs after time zero. In some embodiments, agitation of the matrix and the liquid displacing medium occurs after time zero but before the first sample timepoint (e.g., hour 1). In an embodiment, the second release rate is lower than the first release rate. In an alternative embodiment, the second release rate is higher than the first release rate.

Controlled release of cyclopropene (with “hour zero” meaning composition exposure to a non-equilibrium condition) may alternatively be quantified as a percentage of the rate of release of cyclopropene as compared to the rate of release of cyclopropene at hour one (1), for example. In a non-limiting embodiment, the rate of release of cyclopropene at hour 22, at hour 48, at hour 72, at hour 96, at hour 120, at hour 168, and/or at hour 240 is at least 0.1%, at least 2%, at least 2.5%, at least 10%, at least 20%, at least 30%, at least 40%, at least 50%, at least 60%, at least 75%, at least 90%, or more of the release rate at hour 1.

In some embodiments, no external wetting (contact with liquid of any type) and/or external hydrating (contact with H₂O) is required to liberate cyclopropene from the source of the cyclopropene (e.g., a composition comprising a porous adsorbent material). In some embodiments, cyclopropene can be released from the source of the cyclopropene (e.g., a composition comprising a porous adsorbent material) without the addition of external wetting. The cyclopropene released from the source without addition of external wetting may then contact the plant. However, regarding exposure to a liquid displacing medium, in some embodiments, the composition of the source (e.g., a matrix comprising a porous adsorbent material and a cyclopropene) is contacted with a liquid displacing medium that modifies the release characteristics of cyclopropene from the porous adsorbent material versus the release characteristics of the cyclopropene from the porous adsorbent material merely in a non-equilibrium condition. In some embodiments, the modification of release is immediate (e.g., within seconds or minutes of matrix exposure to the liquid displacing medium). In some embodiments, modification of the release characteristics is acceleration of release of cyclopropene from the composition. In some embodiments, modification of the release characteristics is deceleration of release of cyclopropene from the matrix.

In some embodiments, exposure of the matrix to a liquid displacing medium accelerates the release rate of the cyclopropene from the composition in a non-equilibrium condition versus the release rate of the cyclopropene from the composition merely in the non-equilibrium condition. In some embodiments, exposure of the matrix to a liquid displacing medium decelerates the release rate of the cyclopropene in the non-equilibrium condition from the composition versus the release rate of the cyclopropene from the matrix merely in the non-equilibrium condition.

Examples of potentially suitable liquid displacing media include, but are not limited to, liquids comprising water (e.g., comprising water in an amount of greater than or equal to 50 vol %, greater than or equal to 75 vol %, greater than or equal to 90 vol %, greater than or equal to 95 vol %, greater than or equal to 99 vol %, greater than or equal to 99.9 vol % or greater), and/or organic liquids such as alcohols (e.g., methanol, ethanol, isopropanol, butanol, glycerol, etc.), hydrocarbons (e.g., light hydrocarbon solvents such as pentane, hexane, heptane, toluene), ketones (e.g., acetone), esters (e.g., ethyl acetate). In some embodiments, the liquid displacement medium is tap water (e.g., at 20° C.).

The amount of liquid displacement medium contacted with the source of the cyclopropene may depend on the amount of composition and/or its loading. Enough water may be added to the composition to completely submerge all of the composition (e.g., all of a powder of the composition) and create a free-flowing, easily agitated suspension. In some embodiments, release from a source of cyclopropene comprising a composition is commenced and/or accelerated by contacting the source with at least 0.01 L, at least 0.1 L, at least 0.2 L, at least 0.5 L, and/or up to 1 L, up to 2 L or more of liquid displacement medium (e.g., water) per 100 g of the composition.

While certain sources of the cyclopropene comprising porous adsorbent materials are described above, those of ordinary skill in the art, with the benefit of this disclosure, would be aware of alternative types of compositions that may be used as a source of the cyclopropene (e.g., 1-MCP). In some embodiments, a source of the cyclopropene comprises a complexing agent (e.g., encapsulating the cyclopropene in a “lock-and-key” or “cage” complex). Any of a variety of complexing agents may be employed, such as substituted or unsubstituted cyclodextrins (e.g., alpha-cyclodextrin, beta-cyclodextrin, gamma-cyclodextrin), mono-, oligo-, or polycarbohydrates, porphyrins, phosphazenes, crown ethers, calixarenes, or combinations thereof. An example of a commercially-available source of cyclopropene using alpha-cyclodextrin to release encapsulated 1-MCP is ETHYLBLOC™. The complexing agents may be provided in the source as a powder or polycrystalline material of the complexing agents. Some embodiments include complexing agents associated with surfaces of a porous adsorbent material. In some instances, cyclopropene is released from complexing agents by contacting the complexing agents with a liquid (e.g., water) such that some or all of the complexing agent dissolves. In some embodiments, the source of the cyclopropene comprises curcubit[6]uril. For example, the cyclopropene may be encapsulated within the curcubit[6]uril. Release of a cyclopropene from curcubit[6]uril may involve contacting the curcubit[6]uril with a liquid solution (e.g., comprising water, a salt such as sodium bicarbonate, and/or an acid such as benzoic acid). In some embodiments, the source of the cyclopropene comprises a paper such as cellulose paper. The cyclopropene may be mixed with one or more components such as binder (e.g., a polymer such as polyethylene glycol) and/or adhesives on and/or within the paper. In some embodiments, the source of the cyclopropene comprises a metal-organic-framework (MOF). The cyclopropene may be within pores of the MOF and/or specifically or non-specifically adsorbed to moieties of the MOF structure.

In some embodiments, the source of the cyclopropene comprises a zeolite (e.g., a zeolite comprising a silica and/or aluminum, or a zeolite lacking silica, such as a germanium-containing zeolite).

U.S. Provisional Patent Application No. 63/086,210, filed Oct. 1, 2020, and entitled “Systems and Methods for Application of Active Ingredients to Cannabis,” is incorporated herein by reference in its entirety for all purposes.

The following examples are intended to illustrate certain embodiments of the present invention, but do not exemplify the full scope of the invention.

### Example 1

This example describes the development of male sex organs on a female cannabinoid-producing plant, induced by treatment with the cyclopropene 1-methylcyclopropene (1-MCP).

To examine the effect of 1-MCP exposure, six genetic replicates of a first variety of Cannabis (variety ‘A’) and six genetic replicates of a second variety of Cannabis (variety ‘B’) were grown under greenhouse conditions for a period of four weeks, then transferred to growth chamber conditions with a 12 hour photoperiod for three weeks to induce flower formation. Variety A was from a hybrid strain of 15% sativa and 85% indica bred by BC Bud Depot under the strain name Shiatsu. Variety B was from a hybrid strain of 50% sativa and 50% indica bred by Spectrum under the strain name Jack's Girl. Greenhouse conditions and growth chamber conditions are detailed in Table 1. Next, three of the genetic replicates of each variety were treated with 1-MCP via fumigation in a 295 cubic foot growth chamber for 18 hours using a source of the 1-MCP. The source of the 1-MCP was 250 g of a composition comprising 1-MCP in an amount of 2 wt % loaded in activated carbon as a porous adsorbent material. The treatment was initially activated via the addition of 0.07 gallons of liquid water to the composition, which accelerated release of 1-MCP and established an atmosphere within the growth chamber of 36.3 ppm 1-MCP. Twelve days later, the 18-hour 1-MCP treatment was repeated, and the treatment was repeated again the next day. Control groups of each variety were watered and exposed to identical conditions except that they were never fumigated with 1-MCP.

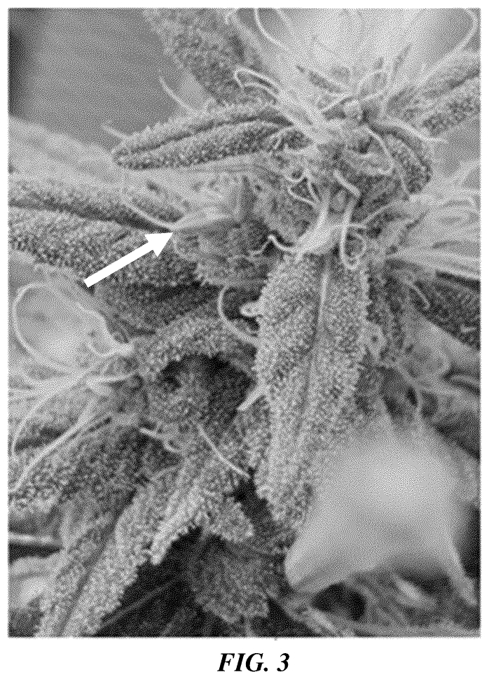

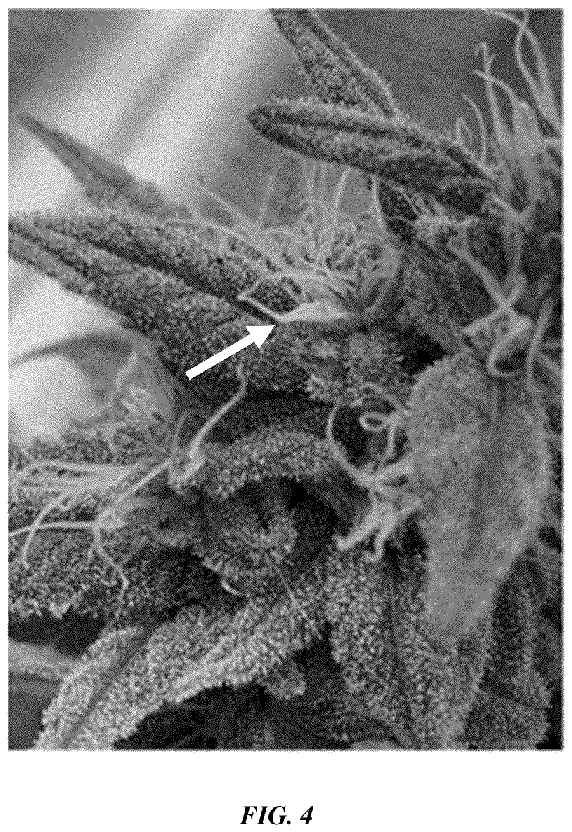

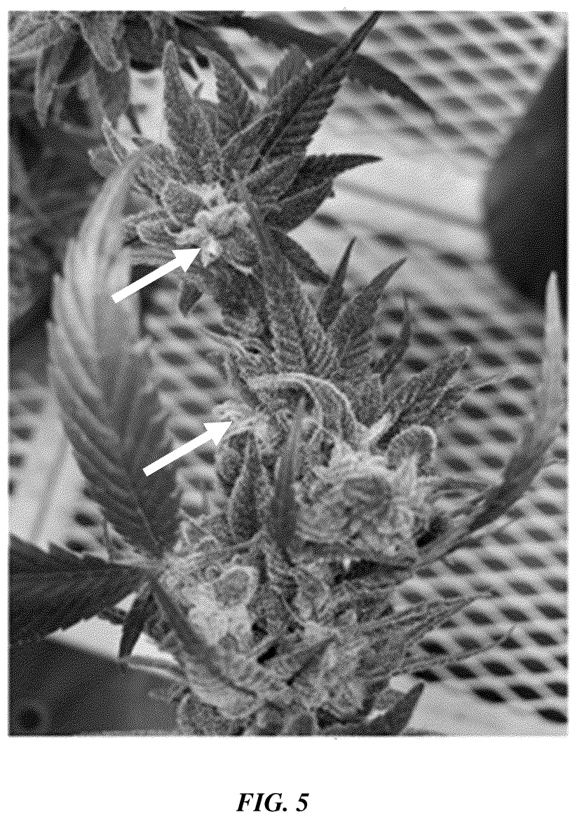

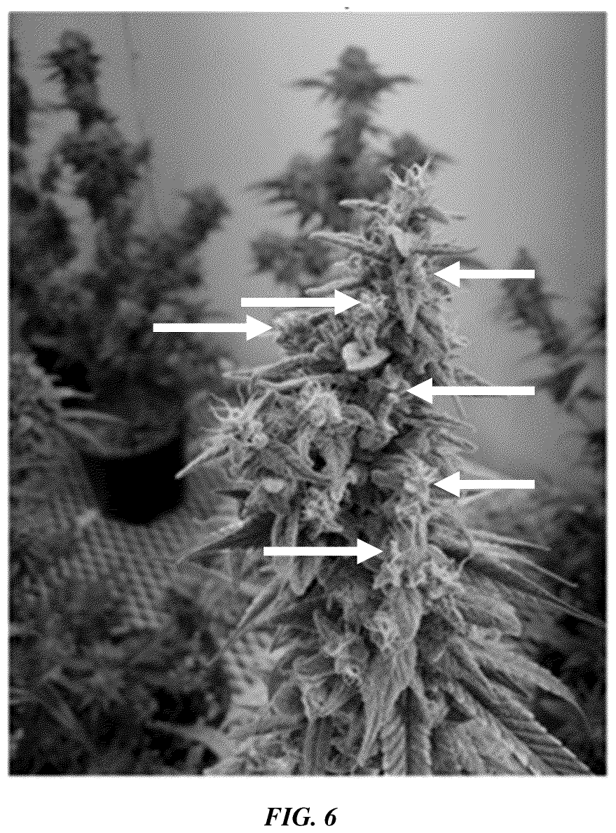

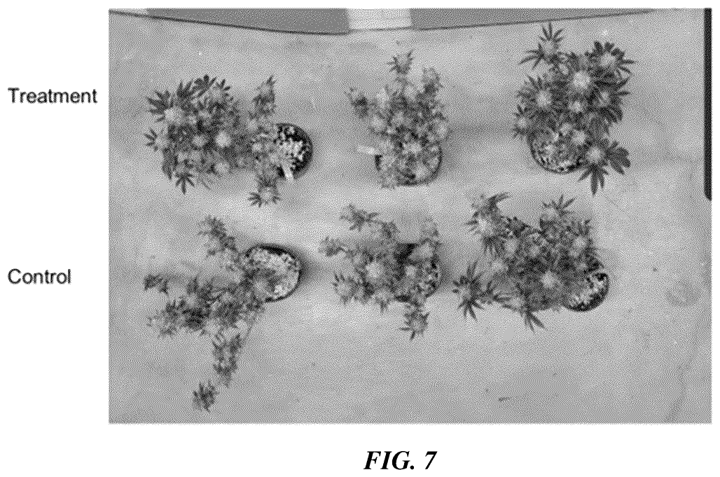

Three days after the final fumigation, stamens were observed on variety ‘B’ genetic replicates treated with 1-MCP. Evidence for this observation is given in FIGS. 3-6. FIG. 3 shows one example of stamen growth on female floral tissue of a variety ‘B’ plant three days after final fumigation, with the stamen indicated by the arrow. FIG. 4 shows the further development of stamen growth on female floral tissue of a variety ‘B’ plant five days after final fumigation, with the stamen indicated by the arrow. FIG. 5 indicates the presence of multiple stamens on female floral tissue of a variety ‘B’ plant 15 days after final fumigation, with the multiple stamens indicated by arrows. FIG. 6 indicates multiple stamens on female floral tissue of a variety ‘B’ plant 19 days after final fumigation, with the multiple stamens indicated by arrows. Stamens were not observed in variety ‘A’ genetic replicates or in either control group. As indicated in Table 2, thirty days after the final 1-MCP treatment, 80-100% of flower clusters displayed staminate growth. Staminate growth was not observed in variety ‘A’ genetic replicates that were treated with 1-MCP. However, a phenotypic tendency towards purple leaves was observed in variety ‘A’ after treatment with 1-MCP. FIG. 7 shows the three 1-MCP-treated variety ‘A’ plants (top, two of three of which were observed to have purples leaves) and three control plants (none of which was observed to have purple leaves).

TABLE 1
Summary of grow conditions.

| Growing | Lights | Lights | | | |
|---|---|---|---|---|---|
| Environment | On | Off | Humidity | Temperature | PAR |
| Greenhouse | 4:30 | 20:30 | 50% (Day) | 70 F. (Day) | >400 |
| | | | 60% | 55 F. | MicroMol/ |
| | | | (Night) | (Night) | m²/s |
| Growth | 6:30 | 18:30 | 40% (Day) | 80 F. (Day) | 425 |
| Chambers | | | 40% | 70 F. | microMol/ |
| | | | (Night) | (Night) | m²/s |

TABLE 2
Percentage of flower clusters on variety ‘B’ genetic replicates displaying
male organs 30 days after the final treatment with 1-MCP.

| | Flower clusters displaying male organs | | |
|---|---|---|---|
| | 30 days after treatment 3 (%) | | |
| | Plant 1 | Plant 2 | Plant 3 |
| Variety B | 97 | 100 | 86 |

### Example 2

This example describes the effect of treatment with the cyclopropene 1-methylcyclopropene (1-MCP) on the biomass of female cannabinoid-producing plants.

To examine the effect of 1-MCP exposure, the genetic replicates from variety A and variety B of Example 1 were measured (i) after plants were dried and (ii) after plants were dried and trimmed, reflecting flower biomass. Measurement (i) provided the total biomass of each genetic replicate, while measurement (ii) provided the mass of consumer-ready product. The drying of the plants was performed by placing the plants into a drying chamber (90° F., 16% relative humidity) for 72 hours prior to measurement and/or trimming.

Table 3 presents these measurements for each plant, as well as the mean total biomass and the mean flower biomass for replicates of the same variety of Cannabis sativa that underwent the same treatment. Genetic replicates of variety A exhibited a (˜22%) increase in total biomass and a (˜10%) increase in flower biomass over the control group when treated with 1-MCP, while genetic replicates of variety B exhibited a small (˜2%) decrease in both total biomass and flower biomass when treated with 1-MCP. The measurement data showed that variety A showed an increase in total biomass and flower biomass when treated with 1-MCP while variety B showed a minor decrease in total biomass and flower biomass when treated with 1-MCP.

TABLE 3
The total biomass and flower biomass of
each plant, as well as replicate-means

| | | | Total | | Flower | |
|---|---|---|---|---|---|---|
| Vari- | | Specimen | Biomass | Group | Biomass | Group |
| ety | Condition | Number | (g) | Mean | (g) | Mean |
| A | Treatment | 1 | 120 | 118.3 | 98 | 95.3 |
| | | 2 | 105 | | 90 | |
| | | 3 | 130 | | 98 | |
| | Control | 4 | 112 | 105 | 92 | 87.6 |
| | | 5 | 100 | | 86 | |
| | | 6 | 103 | | 85 | |
| B | Treatment | 1 | 111 | 115.6 | 95 | 100.3 |
| | | 2 | 121 | | 106 | |
| | | 3 | 115 | | 100 | |
| | Control | 4 | 98 | 118.3 | 86 | 102.3 |
| | | 5 | 132 | | 113 | |
| | | 6 | 125 | | 108 | |

These results demonstrate that treatment with 1-MCP did not have a deleterious effect on the biomass of either variety of Cannabis and can lead to increased biomass (including flower biomass) in at least some varieties.

### Example 3

This example describes the effect of treatment with the cyclopropene 1-methylcyclopropene (1-MCP) on the profile of cannabinoids in cannabinoid-producing plants.

Cannabinoids concentrations were measured in the genetic replicates from variety A and variety B of Example 1 at three time-points: T1—two days before the first treatment with 1-MCP; T2—one week after the first treatment with 1-MCP; and T3—after all 1-MCP treatments, once the genetic replicates had reached full plant maturity. At each timepoint, three samples of floral tissue were collected from each genetic replicate and frozen overnight. To prepare samples of floral tissue for high performance liquid chromatography (HPLC) analysis, frozen floral tissue was ground, extracted in HPLC-grade methanol, and filtered. HPLC was performed on the filtered methanol, providing a cannabinoid profile for each sample of floral tissue.

Analysis of Variance (ANOVA) was performed to evaluate the effect of 1-MCP on cannabinoid content under each set of experimental conditions. For ANOVA tests with statistically significant P-values, Bartlett's test was performed and, in every case, demonstrated homogeneity of variances. In each figure displaying HPLC results, the label ‘ns’ indicates that no statistically significant difference was observed between a pair of observations, while the label ‘*’ indicates a statistically significant difference with P<0.1, and the label ‘**’ indicates a statistically significant difference with P<0.05.

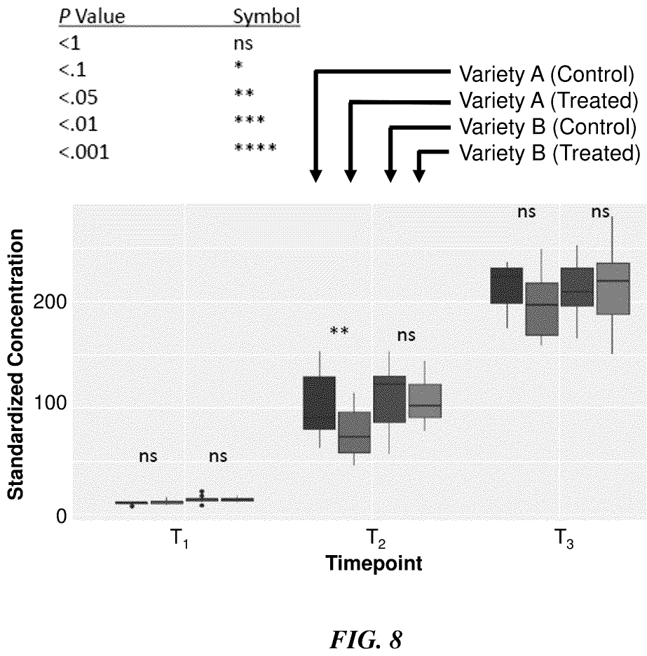

FIG. 8 shows total cannabinoid profiles in genetic replicates of variety A and in genetic replicates of variety B as determined by HPLC. In this figure, the x-axis indicates the timepoint, while the y-axis indicates the concentration in units of Standardized Concentration (defined as 1 milligram of cannabinoid per gram of ground floral tissue). The four combinations of variety and 1-MCP treatment condition are presented in the labeled order at each timepoint. A statistically significant difference occurred at timepoint T2, between genetic replicates of variety A. However, no statistically significant difference was observed in cannabinoid concentrations of the mature plants for either variety.

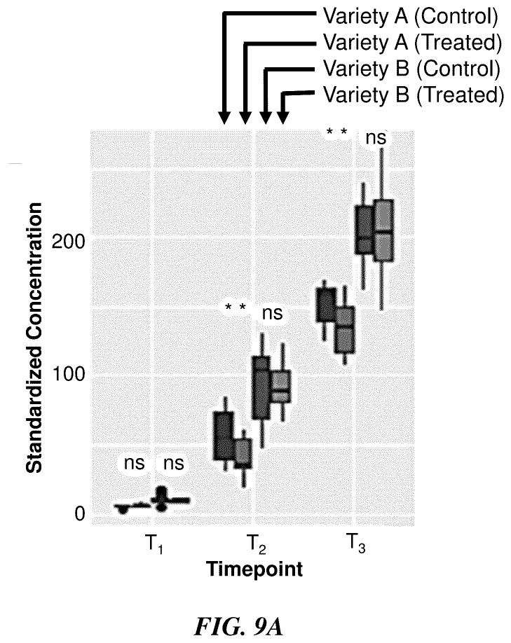

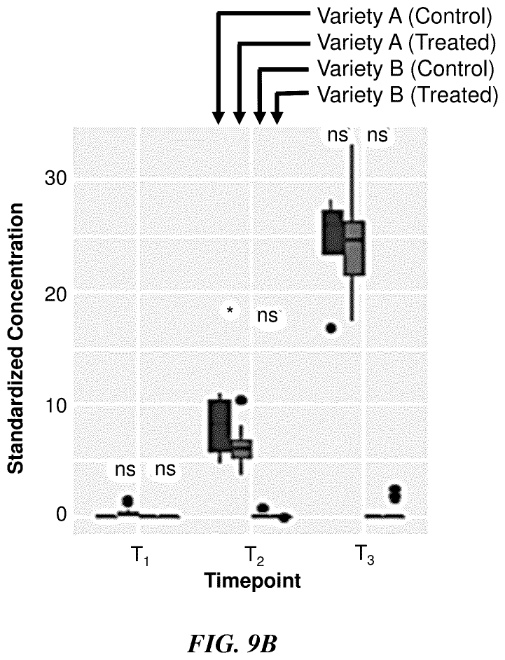

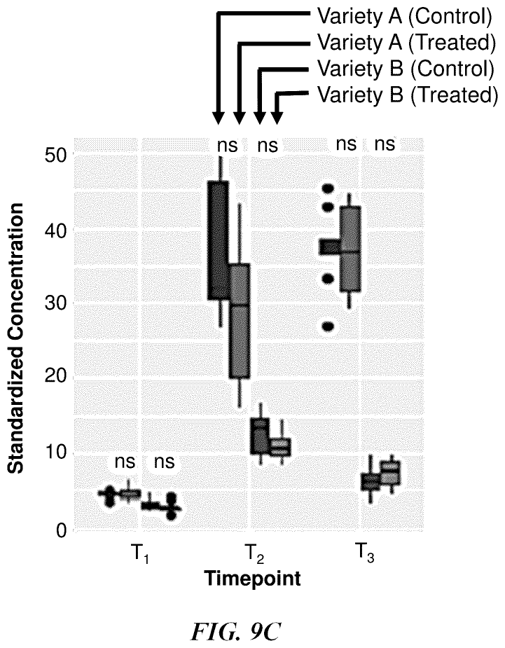

FIGS. 9A-C show profiles of tetrahydrocannabinolic acid (THCA, FIG. 9A), tetrahydrocannabivarinic acid (THCVA, FIG. 9B), and cannabigerolic acid (CBGA, FIG. 9B), the three most abundant cannabinoids at each time point, as determined by HPLC. The axes in these figures are identical to those in FIG. 8. A few statistically significant differences were noted between genetic replicates of variety A. Even when statistically significant, these differences were minor, indicating that treatment with 1-MCP had no deleterious effects on the overall profile of cannabinoids.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for treating a cannabinoid-producing plant, comprising:
a source of a cyclopropene; and
the plant in fluidic communication with the source of the cyclopropene.

2. A system for treating a cannabinoid-producing plant, comprising
a source of a cyclopropene; and
the plant, wherein a distance between the source of the cyclopropene and the plant is less than or equal to 50 m.

3-19. (canceled)

20. A method, comprising:
exposing a cannabinoid-producing plant to a cyclopropene.

21. The method of claim 20, wherein the cyclopropene is 1-methylcyclopropene.

22. (canceled)

23. The method of claim 20, wherein the plant comprises genes of the species Cannabis sativa, Cannabis indica, and/or Cannabis ruderalis.

24. The method of claim 20, wherein the plant comprises genes of the species Cannabis sativa.

25. The method of claim 20, wherein the plant is a female plant.

26. The method of claim 20, wherein the exposing is performed prior to a flowering period of the plant.

27. The method of claim 20, wherein the exposing is performed during a flowering period of the plant.

28. The method of claim 20, wherein the plant is a female plant and the exposing induces the formation of a male organ in the plant.

29. The method of claim 20, wherein, following the exposing, the plant has a total biomass greater than that of an equivalent plant not subjected to the exposing but grown under otherwise identical conditions.

30. The method of claim 20, wherein, following the exposing, the plant has an amount of at least one cannabinoid that is within 20% of that of an equivalent plant not subjected to the exposing but grown under otherwise identical conditions.

31. The method of claim 20, further comprising binding a molecule of the cyclopropene to an ethylene receptor of the plant.

32. The method of claim 20, wherein the exposing comprises exposing the plant to the cyclopropene in a gas phase.

33. The method of claim 20, wherein the exposing comprises control releasing the cyclopropene from a source of the cyclopropene.

34. (canceled)

35. The method of claim 33, wherein the source of the cyclopropene comprises the cyclopropene in an amount of greater than or equal to 0.01 wt % and up to 50 wt % prior to the releasing.

36. The method of claim 33, wherein the source of the cyclopropene is in contact with the plant.

37. The method of claim 33, wherein a distance between the source of the cyclopropene and the plant is greater than or equal to 1 cm.

38. The method of claim 33, wherein a distance between the source of the cyclopropene and the plant is less than or equal to 50 m.

39. The method of claim 20, wherein the exposing comprises establishing a concentration of the cyclopropene in an environment surrounding the plant of greater than or equal to 1 ppb and up to 100 ppm for a period of time of greater than or equal to 1 hour and up to 96 hours.

40. The method of claim 20, wherein the exposing is started within 10 weeks of the plant entering a vegetative stage.

41. The method of claim 20, wherein the exposing comprises releasing the cyclopropene from a porous adsorbent material.

42. The method of claim 41, wherein the porous adsorbent material comprises a carbon material and/or a silicate material.

43. The method of claim 20, wherein the exposing comprises exposing the plant to the cyclopropene via contact with a liquid solution comprising the cyclopropene.

44. The method of claim 20, wherein, following the exposing, the plant has a trimmed biomass greater than that of an equivalent plant not subjected to the exposing but grown under otherwise identical conditions.

45. The method of claim 20, wherein the exposing does not cause a reduction in a total amount of cannabinoids of greater than 20%.

46. The method of claim 41, wherein the porous adsorbent material is incorporated into a sachet.
